(19) United States
(12) Patent Application Publication
(10) Pub. No.: US 2017/0352917 A1
(43) Pub. Date: Dec. 7, 2017

(54) SOLID ELECTROLYTE COMPOSITION, ELECTRODE SHEET FOR BATTERY AND METHOD FOR MANUFACTURING THE SAME, AND ALL SOLID STATE SECONDARY BATTERY AND METHOD FOR MANUFACTURING THE SAME

(71) Applicant: FUJIFILM CORPORATION, Tokyo (JP)

(72) Inventors: Masaomi MAKINO, Kanagawa (JP); Hiroaki MOCHIZUKI, Kanagawa (JP); Tomonori MIMURA, Kanagawa (JP); Katsuhiko MEGURO, Kanagawa (JP)

(21) Appl. No.: 15/683,792

(22) Filed: Aug. 23, 2017

Related U.S. Application Data
(63) Continuation of application No. PCT/JP2015/084577, filed on Dec. 9, 2015.

(30) Foreign Application Priority Data
Feb. 27, 2015 (JP) 2015-039452

(51) Int. Cl. H01M 10/0562; H01B 1/06; H01M 4/139; H01M 4/62

(52) U.S. Cl. CPC H01M 10/0562; H01M 4/621; H01B 1/06; H01M 4/139

(57) ABSTRACT

A solid electrolyte composition includes an inorganic solid electrolyte having a conductivity of ions of metals belonging to Group I or II and a compound represented by General Formula (1). In General Formula (1), R¹ represents an m+n-valent linking group, R² and R³ represent single bonds or divalent linking groups, A¹ represents a monovalent group including one or more groups selected from an acidic group, a group having a basic nitrogen atom, a (meth)acryloyl group, a (meth)acrylamide group, an alkoxysilyl group, an epoxy group, an oxetanyl group, a NCO group, a SN group, a SH group, and a OH group, P¹ represents a group having a hydrocarbon group having 8 or more carbon atoms, m represents 1 to 8, n represents 1 to 9, and m+n satisfies 3 to 10.

(A¹-R²R¹R³-P¹)ₘ (1)

### CROSS-REFERENCE TO RELATED APPLICATIONS

This application is a continuation application of International Application No. PCT/JP2015/084577, filed Dec. 9, 2015, which is incorporated herein by reference. Further, this application claims priority from Japanese Patent Application No. 2015-039452, filed Feb. 27, 2015, which is incorporated herein by reference.

### BACKGROUND OF THE INVENTION

### 1. Field of the Invention

An embodiment of the present invention relates to a solid electrolyte composition, an electrode sheet for a battery and a method for manufacturing the same, and an all solid state secondary battery and a method for manufacturing the same.

### 2. Description of the Related Art

As medium-sized storage batteries or large-sized storage batteries that are used in electric vehicles, domestic storage batteries, and the like, lithium ion batteries which are lightweight batteries and have a large energy density are being used. In lithium ion batteries, organic electrolytic solutions are used as electrolytes, and thus there is a concern of liquid spill or ignition. In recent years, from the viewpoint of improving safety or reliability, studies have been underway regarding all solid state secondary batteries in which non-flammable inorganic solid electrolytes are used as the electrolytes. As inorganic solid electrolytes, there are sulfide-based inorganic solid electrolytes and oxide-based inorganic solid electrolytes, and, for sulfide-based inorganic solid electrolytes, the same degree (approximately 10⁻³ S/cm) of ion conductivity as that of organic electrolytic solutions is realized at room temperature.

All solid state secondary batteries have a structure in which an inorganic electrolyte is sandwiched between electrodes. Electrodes are obtained by adding a binder and a solvent to an electrode active material made of a mixture of a powder-form active material, a solid electrolyte, a conduction aid, and the like so as to prepare a dispersion liquid and applying this dispersion liquid onto the surface of a collector so as to form a film shape.

In a case in which a powder-form mixture is used as a raw material as described above, in all solid state secondary batteries to be formed, there have been problems in that a number of defects are generated in ion conduction paths and electron conduction paths and battery performance degrades. Additionally, the entire electrodes expand or contract due to the repetition of charging and discharging cycles, the contact among particles deteriorates, and thus there have been problems in that grain boundary resistance is generated and charge and discharge characteristics degrade.

As binders having favorable bonding properties with active material particles and favorable adhesiveness with collectors while maintaining flexibility, for example, JP2013-45683A discloses a silicone resin in which a part of the silicone structure is substituted with a polar group. In addition, WO2013/1623A discloses hydrocarbon rubber having a branched structure as a branched binder.

Meanwhile, inorganic solid electrolytes have a problem in that the inorganic solid electrolytes react with moisture in the air and thus cause a decrease in the ion conductivity or the inorganic solid electrolytes are oxidized or reduced and thus deteriorated during the operation of batteries, causing the shortening of the service lives. Regarding this problem, there is a demand for binders capable of protecting the surfaces of inorganic electrolyte particles and favorably suppressing the intrusion of moisture in the air without impairing ion conductivity or suppressing oxidation and reduction caused by electron paths from active materials. For example, JP2009-117168A discloses an all solid state battery including a positive electrode, a negative electrode, a sulfide solid electrolyte located between the positive electrode and the negative electrode, and a liquid-phase substance (insulating oil) coating the sulfide solid electrolyte. According to this all solid state battery, it is possible to prevent the generation of hydrogen sulfide due to reactions with moisture in the atmosphere while ensuring electric conductivity using the sulfide solid electrolyte.

In addition, WO2013/146896A discloses an all solid state battery in which a binder having an adsorption group is used and interacts with the surface of an inorganic solid electrolyte, thereby suppressing deterioration caused by oxidation and reduction.

### SUMMARY OF THE INVENTION

JP2013-45683A discloses a binder having favorable bonding properties with active material particles, WO2013/1623A discloses a branched binder bonding solid electrolyte materials, and JP2009-117168A and WO2013/146896A disclose binders suppressing reactions between inorganic solid electrolytes and moisture. However, the binders disclosed by JP2013-45683A, WO2013/1623A, JP2009-117168A, and WO2013/146896A are not yet favorable enough to cope with the further intensifying need for additional performance improvement of lithium ion batteries, and additional improvement is desired.

An embodiment of the present invention has been made in consideration of what has been described above, an object of the present invention is to provide a solid electrolyte composition in which the deterioration due to moisture and oxidation and reduction deterioration of an inorganic solid electrolyte are suppressed and the dispersion stability is excellent, an electrode sheet for a battery having excellent ion conductivity and moisture resistance and a method for manufacturing the same, and an all solid state secondary battery in which a high voltage is obtained and the cycle service life is long and a method for manufacturing the same, and another object of the present invention is to achieve the above-described object.

The specific means for achieving the objects include the following aspects.

<1> A solid electrolyte composition comprising: an inorganic solid electrolyte (A) having a conductivity of ions of metals belonging to Group I or II of the periodic table; and a compound (B) represented by General Formula (1).

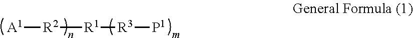

In General Formula (1), R¹ represents an m+n-valent linking group.

R² represents a single bond or a divalent linking group. A¹ represents a monovalent group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group.

R³ represents a single bond or a divalent linking group. P¹ represents a group having a hydrocarbon group having 8 or more carbon atoms.

m represents 1 to 8, n represents 1 to 9, and m+n satisfies 3 to 10.

In a case in which m is 2 or more, two or more P¹'s and two or more R³'s each may be identical to or different from each other. In a case in which n is 2 or more, two or more A¹'s and two or more R²'s each may be identical to or different from each other.

<2> The solid electrolyte composition according to <1>, in which the compound (B) represented by General Formula (1) is a compound represented by General Formula (2).

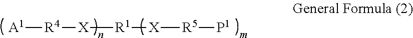

In General Formula (2), R¹ represents an m+n-valent linking group.

R⁴ represents a single bond or a divalent linking group. A¹ represents a monovalent group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group.

R⁵ represents a single bond or a divalent linking group. P¹ represents a group having a hydrocarbon group having 8 or more carbon atoms.

m represents 1 to 8, n represents 1 to 9, and m+n satisfies 3 to 10.

In a case in which m is 2 or more, two or more P¹'s and two or more R⁵'s each may be identical to or different from each other. In a case in which n is 2 or more, two or more A¹'s and two or more R⁴'s each may be identical to or different from each other.

X represents an oxygen atom or a sulfur atom.

<3> The solid electrolyte composition according to <1> or <2>, in which A¹ is a monovalent group including at least one group selected from a carboxyl group, an amino group, a thiol group, and a hydroxyl group.

<4> The solid electrolyte composition according to any one of <1> to <3>, in which a formula weight of the group represented by P¹ is 200 or more and less than 100,000.

<5> The solid electrolyte composition according to any one of <1> to <4>, in which P¹ is at least one group selected from an aliphatic hydrocarbon group having 8 or more carbon atoms, a polyvinyl residue including a hydrocarbon group having 8 or more carbon atoms, a poly(meth)acrylic residue including a hydrocarbon group having 8 or more carbon atoms, a polyester residue including a hydrocarbon group having 8 or more carbon atoms, a polyamide residue including a hydrocarbon group having 8 or more carbon atoms, a fluorinated polyvinyl residue including a hydrocarbon group having 8 or more carbon atoms, a fluorinated poly(meth)acrylic residue including a hydrocarbon group having 8 or more carbon atoms, a fluorinated polyester residue including a hydrocarbon group having 8 or more carbon atoms, and a fluorinated polyamide residue including a hydrocarbon group having 8 or more carbon atoms.

<6> The solid electrolyte composition according to <5>, in which the aliphatic hydrocarbon group having 8 or more carbon atoms is at least one group selected from an alkyl group having 8 or more carbon atoms, an aryl group having 8 or more carbon atoms, a group formed of a saturated fatty acid residue having 8 or more carbon atoms, and a group formed of an unsaturated fatty acid residue having 8 or more carbon atoms.

<7> The solid electrolyte composition according to <5> or <6>, in which the aliphatic hydrocarbon group having 8 or more carbon atoms is a group formed of a saturated fatty acid residue having 8 or more and less than 50 carbon atoms or an unsaturated fatty acid residue having 8 or more and less than 50 carbon atoms.

<8> The solid electrolyte composition according to any one of <1> to <7>, in which R¹ is a polyhydric sugar alcohol residue.

<9> The solid electrolyte composition according to any one of <1> to <8>, in which m is 2 to 5, and n is 2 to 4.

<10> The solid electrolyte composition according to any one of <1> to <9>, in which m+n is 4 to 6.

<11> The solid electrolyte composition according to any one of <1> to <10>, in which a weight-average molecular weight of the compound (B) represented by General Formula (1) is 600 or more and less than 200,000.

<12> The solid electrolyte composition according to any one of <1> to <11>, further comprising: a binder (C).

<13> The solid electrolyte composition according to any one of <1> to <12>, in which the inorganic solid electrolyte (A) is a sulfide-based inorganic solid electrolyte.

<14> The solid electrolyte composition according to any one of <1> to <12>, in which the inorganic solid electrolyte (A) is an oxide-based inorganic solid electrolyte.

<15> The solid electrolyte composition according to any one of <1> to <14>, in which a content of the compound (B) represented by General Formula (1) is 0.01 parts by mass or more and 20 parts by mass or less with respect to 100 parts by mass of the inorganic solid electrolyte (A).

<16> The solid electrolyte composition according to any one of <1> to <15>, further comprising: a hydrocarbon-based solvent as a dispersion medium (D).

<17> An electrode sheet for a battery comprising: a collector; and an inorganic solid electrolyte-containing layer disposed on the collector using the solid electrolyte composition according to any one of <1> to <16>.

<18> The electrode sheet for a battery according to <17>, further comprising: a positive electrode active material layer; a negative electrode active material layer; and an inorganic solid electrolyte layer disposed between the positive electrode active material layer and the negative electrode active material layer, in which at least one layer of the positive electrode active material layer, the negative electrode active material layer, or the inorganic solid electrolyte layer is the inorganic solid electrolyte-containing layer.

<19> A method for manufacturing an electrode sheet for a battery, comprising: a step of applying the solid electrolyte composition according to any one of <1> to <16> onto a collector to form an inorganic solid electrolyte-containing layer.

<20> An all solid state secondary battery comprising: a collector; a positive electrode active material layer; a negative electrode active material layer; and an inorganic solid electrolyte layer disposed between the positive electrode active material layer and the negative electrode active material layer, in which at least one layer of the positive electrode active material layer, the negative electrode active material layer, or the inorganic solid electrolyte layer includes an inorganic solid electrolyte (A) having a conductivity of ions of metals belonging to Group I or II of the periodic table and a compound (B) represented by General Formula (1).

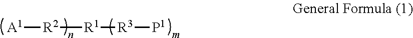

In General Formula (1), R¹ represents an m+n-valent linking group.

R² represents a single bond or a divalent linking group. A¹ represents a monovalent group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group.

R³ represents a single bond or a divalent linking group. P¹ represents a group having a hydrocarbon group having 8 or more carbon atoms.

m represents 1 to 8, n represents 1 to 9, and m+n satisfies 3 to 10.

In a case in which m is 2 or more, two or more P¹'s and two or more R³'s each may be identical to or different from each other. In a case in which n is 2 or more, two or more A¹'s and two or more R²'s each may be identical to or different from each other.

<21> An all solid state secondary battery comprising: the electrode sheet for a battery according to <17> or <18>.

<22> A method for manufacturing an all solid state secondary battery, in which an all solid state secondary battery is manufactured using the electrode sheet for a battery according to <17> or <18>.

<23> A method for manufacturing an all solid state secondary battery, comprising: a step of applying the solid electrolyte composition according to any one of <1> to <16> onto a collector to form an inorganic solid electrolyte-containing layer, thereby manufacturing an electrode sheet for a battery.

According to an embodiment of the present invention, a solid electrolyte composition in which the deterioration due to moisture and oxidation and reduction deterioration of the inorganic solid electrolyte are suppressed and the dispersion stability is excellent, an electrode sheet for a battery having excellent ion conductivity and moisture resistance and a method for manufacturing the same, and an all solid state secondary battery in which a high voltage is obtained, the moisture resistance is excellent, and the cycle service life is long and a method for manufacturing the same.

### BRIEF DESCRIPTION OF THE DRAWINGS

FIG. 1 is a schematic cross-sectional view schematically illustrating an all solid state secondary battery according to an embodiment of the present invention.

FIG. 2 is a side cross-sectional view schematically illustrating a testing device used in examples.

### DESCRIPTION OF THE PREFERRED EMBODIMENTS

Hereinafter, a solid electrolyte composition, an electrode sheet for a battery and a method for manufacturing the same, and an all solid state secondary battery and a method for manufacturing the same will be described in detail.

In the present specification, numerical ranges expressed using “to” indicate ranges including numerical values before and after the “to” as the minimum value and the maximum value respectively.

“Compositions” refer to mixtures in which two or more components are mixed together. Here, substantially homogeneous substances can be considered as compositions, and components may be partially agglomerated or eccentrically located as long as desired effects are exhibited.

<Solid Electrolyte Composition>

The solid electrolyte composition includes an inorganic solid electrolyte (A) having a conductivity of ions of metals belonging to Group I or II of the periodic table and a compound (B) represented by General Formula (1).

The details of action mechanisms in the embodiment of the present invention are not clear, but are assumed as described below.

When the solid electrolyte composition includes a compound having a group capable of interacting with the surface of the inorganic solid electrolyte (A) (the group represented by A¹ in General Formula (1)) and a group including a hydrocarbon group having 8 or more carbon atoms (the group represented by P¹ in General Formula (1)), the group represented by A¹ in the compound represented by General Formula (1) is bonded to the surface of the inorganic solid electrolyte, hydrophobic P¹ is disposed on the surface of the inorganic solid electrolyte, and the hydrophobicity of the inorganic solid electrolyte is further enhanced.

When the hydrophobic P¹ is disposed on the surface of the inorganic solid electrolyte as described above, it is considered that the deterioration of the ion conductivity of the inorganic solid electrolyte caused by moisture or oxidation and reduction reactions can be suppressed.

In addition, the compound represented by General Formula (1) has a branch in the structure, and thus it is possible to efficiently develop an effect of suppressing the deterioration of the inorganic solid electrolyte caused by moisture or oxidation and reduction reactions.

Furthermore, since the compound represented by General Formula (1) has the group represented by P¹, it is considered that, in a case in which a hydrocarbon-based solvent is used as a dispersion medium for the solid electrolyte composition, the composition obtains excellent dispersion stability.

From what has been described above, it is considered that, in the solid electrolyte composition, the oxidation and reduction deterioration of the inorganic solid electrolyte is suppressed, and the dispersion stability is excellent.

Therefore, in a case in which electrode sheets for a battery are produced, excellent ion conductivity and moisture resistance can be obtained, high voltages can be obtained, and all solid state secondary batteries having a long cycle service life can be obtained.

These effects cannot be expected in binders of the related art (for example, the binders described in JP2013-45683A, WO2013/1623A, JP2009-117168A, and WO2013/146896A).

[Inorganic Solid Electrolyte (A)]

The solid electrolyte composition includes at least one inorganic solid electrolyte having a conductivity of ions of metals belonging to Group I or II of the periodic table.

The inorganic solid electrolyte refers to a solid electrolyte formed of an inorganic substance. The solid electrolyte refers to a solid capable of migrating ions in the electrolyte.

The inorganic solid electrolyte does not include organic substances, that is, carbon atoms and is thus clearly differentiated from organic solid electrolytes (polymer electrolytes represented by polyethylene oxide (PEO) or the like and organic electrolyte salts represented by lithium bistrifluoromethane sulfonimide (LiTFSI) or the like).

In addition, since the inorganic solid electrolyte is solid in a steady state, cations and anions are not dissociated or liberated, and the inorganic solid electrolyte is also clearly differentiated from inorganic electrolyte salts in which cations and anions are disassociated or liberated in electrolytic solutions or polymers (LiPF₆, LiBF₄, LiFSI, LiCl, and the like).

The inorganic solid electrolyte in the solid electrolyte composition conducts ions between electrodes when an electrode (positive electrode or negative electrode) active material layer or an inorganic solid electrolyte layer is formed using the solid electrolyte composition and a battery is produced using this layer. Therefore, batteries produced using these layers function as batteries.

The inorganic solid electrolyte is not particularly limited as long as the inorganic solid electrolyte is a compound having a conductivity of ions of metals belonging to Group I or II of the periodic table, and the inorganic solid electrolyte is generally not electron-conductive.

As the inorganic solid electrolyte, solid electrolyte materials that are well known in the lithium ion battery field can be appropriately selected and used. As the inorganic solid electrolyte, (i) sulfide-based inorganic solid electrolytes and (ii) oxide-based inorganic solid electrolytes are preferred from the viewpoint of ion conductivity.

(i) Sulfide-Based Inorganic Solid Electrolytes

Sulfide-based inorganic solid electrolytes are not particularly limited as long as the electrolytes contain sulfur (S) and have an ion conductivity of metals belonging to Group I or II of the periodic table. The sulfide-based inorganic solid electrolytes preferably have electron-insulating properties. Examples thereof include lithium ion-conductive inorganic solid electrolytes satisfying a composition represented by Formula (1).

LiₐM_{b}P_{c}S_{d}Aₑ Formula (1)

In Formula (1), M represents an element selected from B, Zn, Sn, Si, Cu, Ga, Sb, Al, and Ge. Among these elements, B, Sn, Si, Al, and Ge are preferred, and Sn, Al, and Ge are more preferred.

In Formula (1), A represents an element selected from I, Br, Cl, and F. Among these, I and Br are preferred, and I is more preferred.

In Formula (1), a to e represent the compositional ratios among the respective elements, and a:b:c:d:e satisfies 1 to 12:0 to 1:1:2 to 12:0 to 5 in terms of element ratios. Regarding the compositional ratios among the respective elements, a is preferably 1 to 9 and more preferably 1.5 to 4. b is preferably 0 to 0.5. d is preferably 3 to 7 and more preferably 3.25 to 4.5. e is preferably 0 to 3 and more preferably 0 to 2.

In Formula (1), b and e are preferably zero, a:b:c:d:e is more preferably 1 to 9:0:1:3 to 7:0, and a:b:c:d:e is still more preferably 1.5 to 4:0:1:3.25 to 4.5:0.

The compositional ratios among the respective elements can be controlled by adjusting the amounts of raw material compounds blended in the case of the manufacturing the sulfide-based inorganic solid electrolyte as described below.

The sulfide-based inorganic solid electrolytes may be amorphous (glass) or sulfide glass ceramics that are partially crystallized (made into glass ceramics) (glass ceramic-form sulfide-based inorganic solid electrolytes).

The sulfide-based inorganic solid electrolytes are preferably Li/P/S-based glass and Li/P/S-based glass ceramic from the viewpoint of excellent ion conductivity.

The Li/P/S-based glass refers to an amorphous sulfide-based inorganic solid electrolyte including a Li element, a P element, and a S element, and the Li/P/S-based glass ceramic refers to a glass ceramic-form sulfide-based inorganic solid electrolyte including a Li element, a P element, and a S element.

The Li/P/S-based glass and the Li/P/S-based glass ceramic can be manufactured from [1] lithium sulfide (Li₂S) and diphosphorus pentasulfide (P₂S₅), [2] lithium sulfide and at least one of a phosphorus single body or a sulfur single body, or [3] lithium sulfide, diphosphorus pentasulfide, and at least one of a phosphorus single body or a sulfur single body.

The ratio between Li₂S and P₂S₅ in Li/P/S-based glass and Li/P/S-based glass ceramic is preferably 65:35 to 85:15 and more preferably 68:32 to 75:25 in terms of the molar ratio (Li₂S:P₂S₅).

When the ratio between Li₂S and P₂S₅ is set in this range, it is possible to increase the lithium ion conductivity. Specifically, the lithium ion conductivity can be preferably set to 1×10⁻⁴ S/cm or more and more preferably set to 1×10⁻³ S/cm or more.

There is no particular upper limit, but 1×10⁻¹ S/cm or less is realistic.

Specific examples of the compound include solid electrolytes including a raw material composition containing Li₂S and a sulfide of an element of Groups XIII to XV. Specific examples thereof include Li₂S/P₂S₅, Li₂S/LiI/P₂S₅, Li₂S/LiI/Li₂O/P₂S₅, Li₂S/LiBr/P₂S₅, Li₂S/Li₂O/P₂S₅, Li₂S/Li₃PO₄/P₂S₅, Li₂S/P₂S₅/P₂O₅, Li₂S/P₂S₅/SiS₂, Li₂S/P₂S₅/SnS, Li₂S/P₂S₅/Al₂S₃, Li₂S/GeS₂, Li₂S/GeS₂/ZnS, Li₂S/Ga₂S₃, Li₂S/GeS₂/Ga₂S₃, Li₂S/GeS₂/P₂S₅, Li₂S/GeS₂/Sb₂S₅, Li₂S/GeS₂/Al₂S₃, Li₂S/SiS₂, Li₂S/Al₂S₃, Li₂S/SiS₂/Al₂S₃, Li₂S/SiS₂/P₂S₅, Li₂S/SiS₂/P₂S₅/LiI, Li₂S/SiS₂/LiI, Li₂S/SiS₂/Li₄SiO₄, Li₂S/SiS₂/Li₃PO₄, Li₁₀GeP₂S₁₂ and the like.

Among these, solid electrolytes including Li₂S/P₂S₅, Li₂S/GeS₂/Ga₂S₃, Li₂S/LiI/P₂S₅, Li₂S/LiI/Li₂O/P₂S₅, Li₂S/GeS₂/P₂S₅, Li₂S/SiS₂/P₂S₅, Li₂S/SiS₂/Li₄SiO₄, Li₂S/SiS₂/Li₃PO₄, Li₂S/Li₃PO₄/P₂S₅, Li₂S/GeS₂/P₂S₅, or Li₁₀GeP₂S₁₂ are preferred. The above-described crystalline raw material compositions or amorphous raw material compositions are preferred due to their high lithium ion conductivity.

Examples of a method for synthesizing sulfide solid electrolyte materials using the above-described raw material composition include an amorphorization method. Examples of the amorphorization method include a mechanical milling method and a melting quenching method, and, among these, the mechanical milling method is preferred. The mechanical milling method is preferred because treatments at normal temperature become possible and it is possible to simplify manufacturing steps.

(ii) Oxide-Based Inorganic Solid Electrolytes

Oxide-based inorganic solid electrolytes are not particularly limited as long as the electrolytes contain oxygen (O) and have an ion conductivity of metals belonging to Group I or II of the periodic table. The oxide-based inorganic solid electrolytes are preferably compounds having electron-insulating properties.

Specific examples of the compounds include LiₓLa_{y}TiO₃ [x=0.3 to 0.7 and y=0.3 to 0.7] (LLT), LiₓLa_{y}Zr_{z}MₘOₙ (M is at least one element of Al, Mg, Ca, Sr, V, Nb, Ta, Ti, Ge, In, or Sn, x satisfies 5≦x≦10, y satisfies 1≦y≦4, z satisfies 1≦z≦4, m satisfies 0≦m≦2, and n satisfies 5≦n≦20), LiₓB_{y}M_{z}Oₙ (in the formula, M is at least one element of C, S, Al, Si, Ga, Ge, In, or Sn, x satisfies 0≦x≦5, y satisfies 0≦y≦1, z satisfies 0≦z≦1, and n satisfies 0≦n≦6), Liₓ(Al, Ga)_{y}(Ti, Ge)_{z}SiₐPₘOₙ (here, 1≦x≦3, 0≦y≦1, 0≦z≦2, 0≦a≦1, 1≦m≦7, and 3≦n≦13), Li₍₃₋₂ₓ₎MₓDO (x represents a numerical value of 0 or more and 0.1 or less, M represents a divalent metal atom, and D represents a halogen atom or a combination of two or more halogen atoms), LiₓSi_{y}O_{z} (1≦x≦5, 0≦y≦3, and 1≦z≦10), LiₓS_{y}O_{z} (1≦x≦3, 0≦y≦2, and 1≦z≦10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35} TiO₃ having a perovskite-type crystal structure, LiTi₂P₃O₁₂ having a natrium super ionic conductor (NASICON)-type crystal structure, Li_{1+x+y}(Al, Ga)ₓ(Ti, Ge)₂₋ₓSi_{y}P_{3-y}O₁₂ (here, 0≦x≦1 and 0≦y≦1), Li₇La₃Zr₂O₁₂ having a garnet-type crystal structure, and the like. In addition, phosphorus compounds including Li, P, and O are also preferred. Examples thereof include lithium phosphate (Li₃PO₄), LiPON in which part of oxygen atoms in lithium phosphate are substituted with nitrogen atoms, and LiPOD (D represents at least one element selected from Ti, V, Cr, Mn, Fe, Co, Ni, Cu, Zr, Nb, Mo, Ru, Ag, Ta, W, Pt, Au, or the like). In addition, LiAON (A is at least one element selected from Si, B, Ge, Al, C, Ga, or the like) and the like can also be preferably used.

Among these, LiₓLa_{y}TiO₃ [x=0.3 to 0.7 and y=0.3 to 0.7] (LLT), LiₓLa_{y}Zr_{z}MₘOₙ (M is at least one element of Al, Mg, Ca, Sr, V, Nb, Ta, Ti, Ge, In, or Sn, x satisfies 5≦x≦10, y satisfies 1≦y≦4, z satisfies 1≦z≦4, m satisfies 0≦m≦2, and n satisfies 5≦n≦20), Li₇La₃Zr₂O₁₂ (LLZ), Li₃BO₃, Li₃BO₃/Li₂SO₄, and Liₓ(Al, Ga)_{y}(Ti, Ge)_{z}SiₐPₘOₙ (here, 1≦x≦3, 0≦y≦1, 0≦z≦2, 0≦a≦1, 1≦m≦7, and 3≦n≦13) are preferred. These compounds may be used singly or two or more compounds may be used in combination.

The ion conductivity of the lithium ion-conductive oxide-based inorganic solid electrolyte is preferably 1×10⁻⁶ S/cm or more, more preferably 5×10⁻⁶ S/cm or more, and particularly preferably 1×10⁻⁵ S/cm or more.

In the solid electrolyte composition, the sulfide-based inorganic solid electrolyte is preferably used.

The sulfide-based inorganic solid electrolyte has a high ion conductivity, and thus the effects of the embodiment of the present invention in all solid state secondary batteries are significantly exhibited.

The inorganic solid electrolyte may be used singly or two or more inorganic solid electrolytes may be used in combination.

The ion conductivity is a value (S/cm) calculated from the following expression by measuring the alternating-current impedance of the inorganic solid electrolyte layer formed in a predetermined thickness using a 1255B FREQUENCY RESPONSE ANALYZER (manufactured by Solartron Metrology) at a voltage amplitude of 5 mV and a frequency in a range of 1 MHz to 1 Hz so as to obtain the resistance in the film thickness direction. The ion conductivity is measured in a constant-temperature tank (30° C.).

Ion conductivity=1000×layer thickness (cm)/(resistance (Ω)×layer area (cm²))

The shape of the inorganic solid electrolyte is not particularly limited, but is preferably particulate.

The volume-average particle diameter of the inorganic solid electrolyte is not particularly limited, but is preferably 0.01 μm or more and more preferably 0.1 μm or more. The upper limit of the volume-average particle diameter is preferably 100 μm or less and more preferably 50 μm or less.

The volume-average particle diameter is a value measured using a laser diffraction/scattering particle size distribution analyzer LA-920 (manufactured by Horiba Ltd.).

When the satisfaction of both of the battery performance and an effect of reducing and maintaining the interface resistance is taken into account, the content of the inorganic solid electrolyte in the solid electrolyte composition is preferably 5% by mass or more, more preferably 10% by mass or more, and still more preferably 20% by mass or more with respect to 100% by mass of the solid component of the solid electrolyte composition. From the same viewpoint, the upper limit is preferably 99.9% by mass or less, more preferably 99.5% by mass or less, and still more preferably 99.0% by mass or less.

However, when a positive electrode active material or negative electrode active material described below is jointly used, the total mass of the inorganic solid electrolyte and the positive electrode active material or negative electrode active material is preferably in the above-described range.

[Compound (B) Represented by General Formula (1)]

The solid electrolyte composition includes at least one compound represented by General Formula (1) (hereinafter, also referred to as polymer dispersant).

When adsorbed to the surface of the inorganic solid electrolyte, the compound represented by General Formula (1) is capable of preventing the inorganic solid electrolyte from moisture and oxidation and reduction reactions. Therefore, when including the compounds represented by General Formula (1), the solid electrolyte composition has an effect of suppressing the deterioration due to moisture and oxidation and reduction deterioration of the inorganic solid electrolyte.

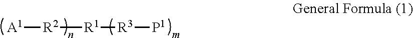

In General Formula (1), R¹ represents an m+n-valent linking group.

The m+n-valent linking group is preferably a group formed of a combination of 1 to 100 carbon atoms, 0 to 10 nitrogen atoms, 0 to 50 oxygen atoms, 1 to 200 hydrogen atoms, and 0 to 20 sulfur atoms. This group may be not substituted or may further have a substituent.

Specific examples of the m+n-valent linking group include tri- or higher-valent linking groups obtained by combining two or more tri- or higher-valent structural units described below or structural units described below (including cyclic structures).

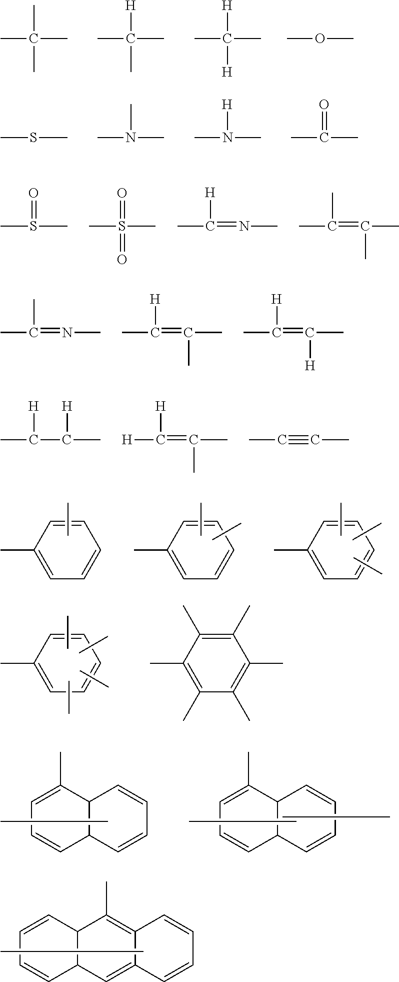

In a case in which m+n-valent linking group further has a substituent, examples of the substituent include alkyl groups having 1 to 20 carbon atoms such as a methyl group and an ethyl group, aryl groups having 6 to 16 carbon atoms such as a phenyl group and a naphthyl group, a hydroxyl group, an amino group, a carboxyl group, a sulfonamide group, a N-sulfonylamide group, acyloxy groups having 1 to 6 carbon atoms such as an acetoxy group, alkoxy groups having 1 to 6 carbon atoms such as a methoxy group and an ethoxy group, halogen atoms such as chlorine and bromine, alkoxycarbonyl groups having 2 to 7 carbon atoms such as a methoxycarbonyl group, an ethoxycarbonyl group, and a cyclohexyloxycarbonyl group, a cyano group, and carbonic acid ester groups such as a t-butyl carbonate.

The m+n-valent linking group is preferably a group represented by any one of General Formula (1a) to General Formula (1d).

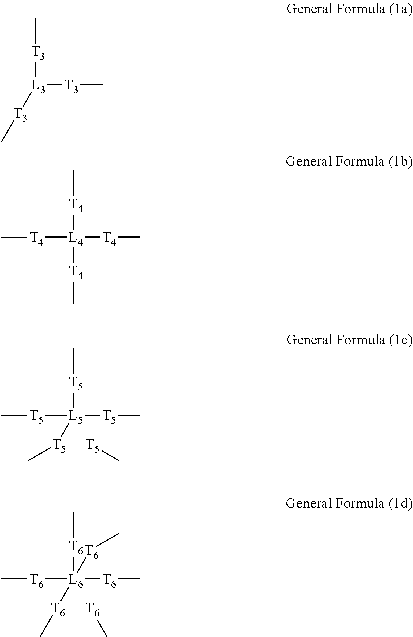

In General Formula (1a), L₃ represents a trivalent group. T₃ represents a single bond or a divalent linking group, and three T₃'s may be identical to or different from one another.

Preferred aspects of L₃ include trivalent hydrocarbon groups (the number of carbon atoms is preferably 1 to 10, and the hydrocarbon groups may be aromatic hydrocarbon groups or aliphatic hydrocarbon groups) and trivalent heterocyclic groups (preferably heterocyclic groups of five- to seven-membered rings), and the hydrocarbon groups may include a heteroatom (for example, —O—). Specific examples of L₃ include glycerin residues, trimethylolpropane residues, phloroglucinol residues, cyclohexanetriol residues, and the like.

In General Formula (1b), L₄ represents a tetravalent group. T₄ represents a single bond or a divalent linking group, and four T₄'s may be identical to or different from one another.

Preferred aspects of L₄ include tetravalent hydrocarbon groups (the number of carbon atoms is preferably 1 to 10, and the hydrocarbon groups may be aromatic hydrocarbon groups or aliphatic hydrocarbon groups) and tetravalent heterocyclic groups (preferably heterocyclic groups of five- to seven-membered rings), and the hydrocarbon groups may include a heteroatom (for example, —O—). Specific examples of L₄ include pentaerythritol residues, ditrimethylolpropane residues, and the like.

In General Formula (1c), L₅ represents a pentavalent group. T₅ represents a single bond or a divalent linking group, and five T₅'s may be identical to or different from one another.

Preferred aspects of L₅ include pentavalent hydrocarbon groups (the number of carbon atoms is preferably 2 to 10, and the hydrocarbon groups may be aromatic hydrocarbon groups or aliphatic hydrocarbon groups) and pentavalent heterocyclic groups (preferably heterocyclic groups of five- to seven-membered rings), and the hydrocarbon groups may include a heteroatom (for example, —O—). Specific examples of L₅ include arabinitol residues, phloroglucidol residues, cyclohexanepentaol residues, and the like.

In General Formula (1d), L₆ represents a hexavalent group. T₆ represents a single bond or a divalent linking group, and six T₆'s may be identical to or different from one another.

Preferred aspects of L₆ include hexavalent hydrocarbon groups (the number of carbon atoms is preferably 2 to 10, and the hydrocarbon groups may be aromatic hydrocarbon groups or aliphatic hydrocarbon groups) and hexavalent heterocyclic groups (preferably heterocyclic groups of six- or seven-membered rings), and the hydrocarbon groups may include a heteroatom (for example, —O—). Specific examples of L₆ include mannitol residues, sorbitol residues, dipentaerythritol residues, hexahydroxybenzene, hexahydroxycyclohexane residues, and the like.

In General Formula (1a) to General Formula (1d), specific examples and preferred aspects of the divalent linking groups represented by T₃ to T₆ are the same as those of divalent linking groups represented by R² described below.

In addition, in General Formula (1), R¹ is preferably a polyhydric sugar alcohol residue. Examples of the polyhydric sugar alcohol include glycerin, trimethylolpropane, pentaerythritol, ditrimethylolpropane, arabinitol, mannitol, sorbitol, and dipentaerythritol.

In General Formula (1), specific examples of the (m+n)-valent linking group represented by R¹ include specific example (1) to specific example (23) below. However, the embodiment of the present invention is not limited thereto.

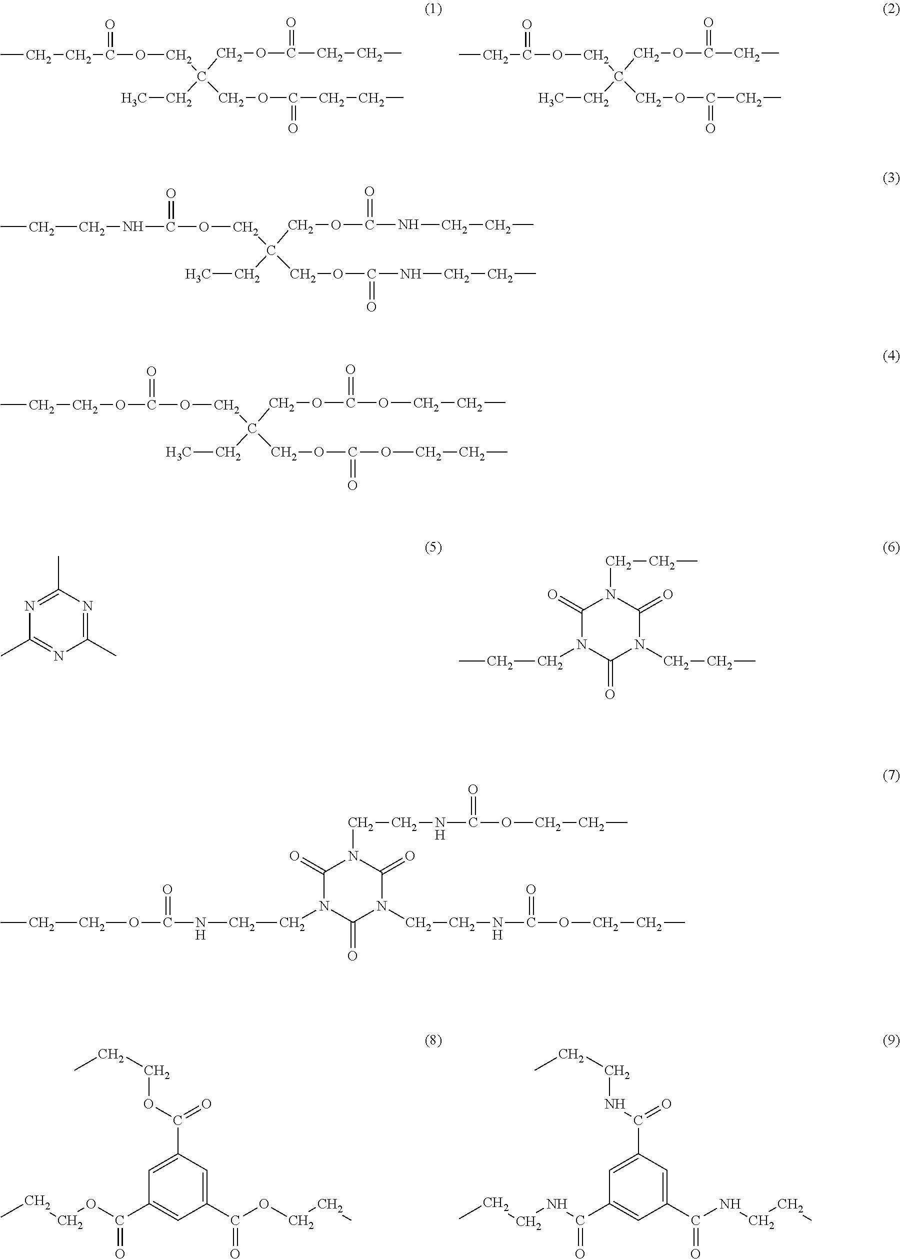

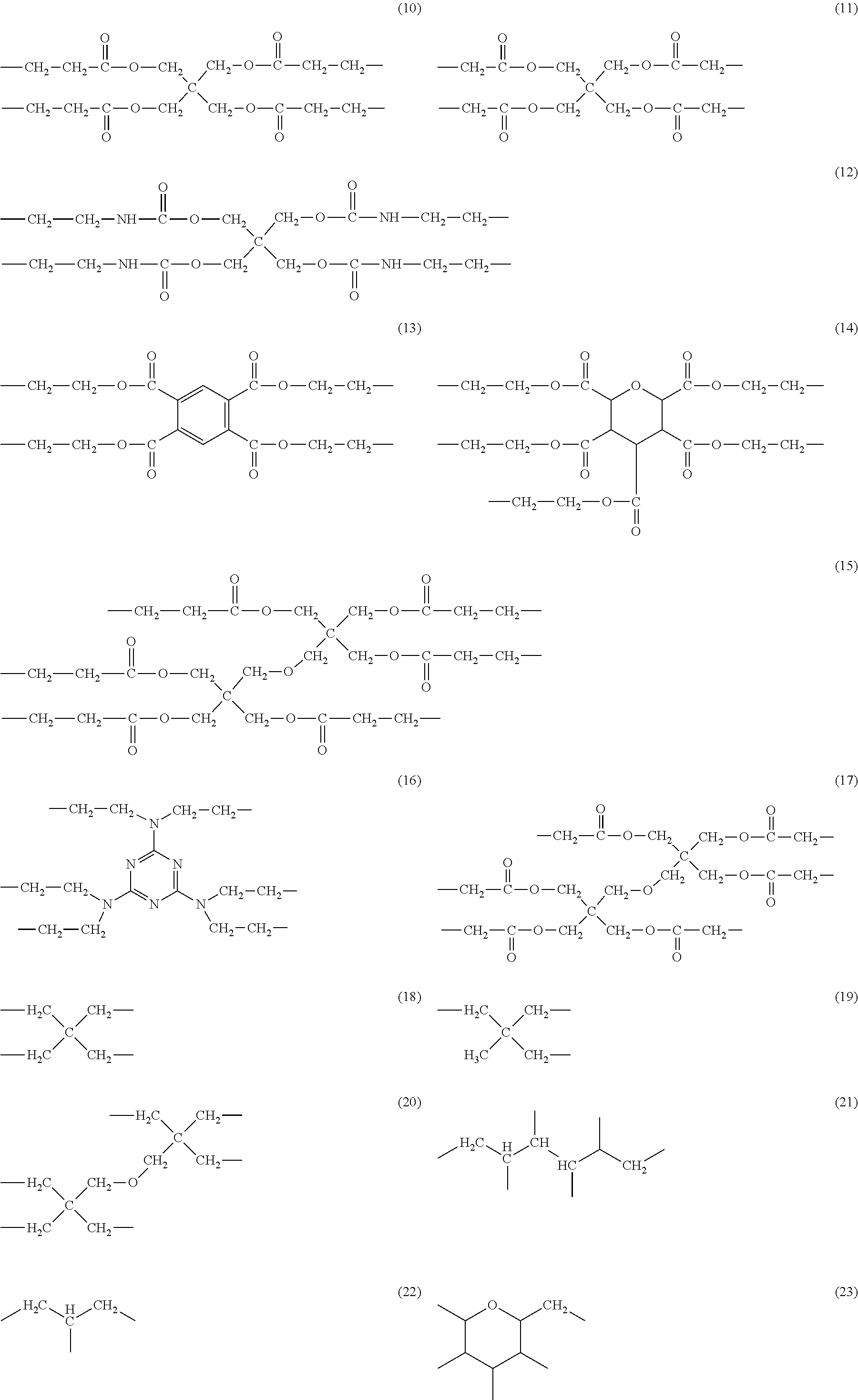

Among specific example (1) to specific example (23), specific example (1), specific example (2), specific example (10), specific example (11), and specific example (16) to specific example (20) are preferred from the viewpoint of procurement of raw materials, ease of synthesis, and solubility in a variety of solvents.

The weight-average molecular weight of the m+n-valent linking group represented by R¹ is not particularly limited, but is preferably 3,000 or less and more preferably 1,500 or less from the viewpoint of the superior dispersibility of the inorganic solid electrolyte and the viewpoint of effects of protecting the surface of the inorganic solid electrolyte and improving moisture resistance and oxidation and reduction resistance. The lower limit of the weight-average molecular weight of the m+n-valent linking group is not particularly limited, but is preferably 50 or more, more preferably 100 or more, and still more preferably 500 or more from the viewpoint of ease of synthesis in the case of the synthesis of General Formula (1).

The weight-average molecular weight is measured by directly connecting HPC-8220GPC (manufactured by Tosoh Corporation), a guard column: TSKguardcolumn Super HZ-L, and columns: TSKgel Super HZM-M, TSKgel Super HZ4000, TSKgel Super HZ3000, and TSKgel Super HZ2000, setting the column temperatures to 40° C., injecting a tetrahydrofuran solution (10 μl) having a specimen concentration of 0.1% by mass, causing tetrahydrofuran to flow as an eluting solvent at a flow rate of 0.35 ml per minute, and detecting a specimen peak using a differential refractive index (RI) detector. In addition, the weight-average molecular weight is calculated using a calibration curve produced using standard polystyrene.

In General Formula (1), A¹ represents a group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group (hereinafter, also collectively referred to as “adsorption portions”). Meanwhile, “(meth)acryloyl” means acryloyl or methacryloyl, and “(meth)acrylic” means acrylic or methacrylic.

This group easily interacts with the inorganic solid electrolyte and functions as a so-called adsorption group. In General Formula (1), in a case in which n is 2 or more, two or more A¹'s may be identical to or different from each other.

In one A¹, at least one adsorption portion needs to be included, and two or more adsorption portions may be included. The “group including at least one group selected from the adsorption portions” is preferably a monovalent group formed by bonding the adsorption portion and a group formed of a combination of 1 to 200 carbon atoms, 0 to 20 nitrogen atoms, 0 to 100 oxygen atoms, 1 to 400 hydrogen atoms, and 0 to 40 sulfur atoms.

Meanwhile, in a case in which the adsorption portion is capable of forming a monovalent group, the adsorption portion itself may be the group represented by A¹.

In addition, aspects of A¹ including two or more adsorption portions include monovalent groups formed by bonding two or more adsorption portions through a chain-like saturated hydrocarbon group (which may have a linear shape or branched shape and preferably has 1 to 10 carbon atoms), a cyclic saturated hydrocarbon group (preferably having 3 to 10 carbon atoms), an aromatic group (preferably having 5 to 10 carbon atoms, for example, a phenylene group), or the like, and a monovalent group formed by bonding two or more adsorption portions through a chain-like saturated hydrocarbon group is preferred.

Hereinafter, individual groups that are “adsorption portions” will be described in detail.

The “acidic group” in A¹ in General Formula (1) is, for example, preferably a carboxyl group, a sulfonic acid group, a monosulfonic acid ester group, a phosphoric acid group, a monophosphoric acid ester group, or a boric acid group, more preferably a carboxyl group, a sulfonic acid group, a monosulfonic acid ester group, a phosphoric acid group, or a monophosphoric acid ester group, and still more preferably a carboxyl group, a sulfonic acid group, or a phosphoric acid group.

Examples of the method for introducing the acidic group into A¹ include a method of carrying out Michael addition of a monomer having an acidic group, for example, (meth)acrylic acid, itaconic acid, or the like to the m+n-valent linking group represented by R¹ and a method of opening the ring of, for example, a maleic anhydride, a phthalic anhydride, a succinic anhydride, or the like.

Preferred examples of the “group having a basic nitrogen atom” in A¹ in General Formula (1) include an amino group (—NH₂), a substituted imino group (—NHR⁸, —NR⁹R¹⁰; here, R⁸, R⁹, and R¹⁰ each independently represent an alkyl group having 1 to 20 carbon atoms, an aryl group having 6 or more carbon atoms, or an aralkyl group having 7 or more carbon atoms), a guanidyl group represented by Formula (a1), an amidinyl group represented by Formula (a2), and the like.

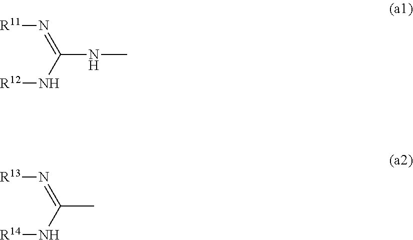

In Formula (a1), R¹¹ and R¹² each independently represent an alkyl group having 1 to 20 carbon atoms, an aryl group having 6 or more carbon atoms, or an aralkyl group having 7 or more carbon atoms.

In Formula (a2), R¹³ and R¹⁴ each independently represent an alkyl group having 1 to 20 carbon atoms, an aryl group having 6 or more carbon atoms, or an aralkyl group having 7 or more carbon atoms.

Among these, an amino group (—NH₂), a substituted imino group (—NHR⁸, —NR⁹R¹⁰; here, R⁸, R⁹, and R¹⁰ each independently represent an alkyl group having 1 to 10 carbon atoms, a phenyl group, or a benzyl group), a guanidyl group represented by Formula (a1) [in Formula (a1), R¹¹ and R¹² each independently represent an alkyl group having 1 to 10 carbon atoms, a phenyl group, or a benzyl group], an amidinyl group represented by Formula (a2) [in Formula (a2), R¹³ and R¹⁴ each independently represent an alkyl group having 1 to 10 carbon atoms, a phenyl group, or a benzyl group], and the like are more preferred.

Particularly, an amino group (—NH₂), a substituted imino group (—NHR⁸, —NR⁹R¹⁰; here, R⁸, R⁹, and R¹⁰ each independently represent an alkyl group having 1 to 5 carbon atoms, a phenyl group, or a benzyl group), a guanidyl group represented by Formula (a1) [in Formula (a1), R¹¹ and R¹² each independently represent an alkyl group having 1 to 5 carbon atoms, a phenyl group, or a benzyl group], an amidinyl group represented by Formula (a2) [in Formula (a2), R¹³ and R¹⁴ each independently represent an alkyl group having 1 to 5 carbon atoms, a phenyl group, or a benzyl group], and the like are preferably used.

As adsorption portion other than the above-described adsorption portions, a (meth)acryloyl group, a (meth)acrylamide group, an alkoxysilyl group, an epoxy group, an oxetanyl group, an isocyanate group, a cyano group, a thiol group, and a hydroxyl group are preferably used.

In General Formula (1), A¹ is preferably a monovalent group including at least one group selected from a carboxyl group, an amino group, a thiol group, and a hydroxyl group since this group easily interacts with the inorganic solid electrolyte.

In General Formula (1), R²'s each independently represent a single bond or a divalent linking group. nR²'s may be identical to or different from each other.

The divalent linking group is preferably a group formed of a combination of 1 to 100 carbon atoms, 0 to 10 nitrogen atoms, 0 to 50 oxygen atoms, 1 to 200 hydrogen atoms, and 0 to 20 sulfur atoms. This group may be not substituted or may further have a substituent.

More specifically, the divalent linking group may be, for example, a divalent hydrocarbon group (divalent saturated hydrocarbon group or divalent aromatic hydrocarbon group; the divalent saturated hydrocarbon group may have a linear shape, a branched shape, or a cyclic shape and preferably has 1 to 20 carbon atoms, and examples thereof include an alkylene group; in addition, the divalent aromatic hydrocarbon group preferably has 5 to 20 carbon atoms, and examples thereof include a phenylene group; additionally, the divalent aromatic hydrocarbon group may be an alkenylene group or alkynylene group). Examples thereof include divalent heterocyclic groups, —O—, —S—, —SO₂—, —NR_{L}—, —CO—, —COO—, —CONR_{L}—, —SO₃—, —SO₂NR_{L}—, groups formed by combining two or more groups described above (for example, an alkyleneoxy group, an alkyleneoxycarbonyl group, an alkylene carbonyloxy group, and the like), and the like. Here, R_{L} represents a hydrogen atom or an alkyl group (preferably having 1 to 10 carbon atoms).

The divalent linking group may have a substituent, and, in a case in which the divalent linking group has a substituent, examples of the substituent include alkyl groups having 1 to 20 carbon atoms such as a methyl group and an ethyl group, aryl groups having 6 to 16 carbon atoms such as a phenyl group and a naphthyl group, a hydroxyl group, an amino group, a carboxyl group, a sulfonamide group, a N-sulfonylamide group, acyloxy groups having 1 to 6 carbon atoms such as an acetoxy group, alkoxy groups having 1 to 6 carbon atoms such as a methoxy group and an ethoxy group, halogen atoms such as chlorine and bromine, alkoxycarbonyl groups having 2 to 7 carbon atoms such as a methoxycarbonyl group, an ethoxycarbonyl group, and a cyclohexyloxycarbonyl group, a cyano group, and carbonic acid ester groups such as a t-butyl carbonate.

In General Formula (1), R³'s each independently represent a single bond or a divalent linking group. In a case in which m is 2 or more, two or more R³'s may be identical to or different from each other. The divalent linking group is the same as the divalent linking group represented by R² described above.

Examples of a divalent linking group include an alkylene group, an ether group, a carbonyl group, and combinations thereof. Examples of the combinations include an ester group (—C(═O)O—), a carbonate group (—OC(═O)O—), a carbamate group (—OC(═O)NR—), an amide group (—C(═O)NR—), and the like. R is a hydrogen atom or an alkyl group. Meanwhile, the orientation of linkage does not matter.

In General Formula (1), P¹ represents a group including a hydrocarbon group having 8 or more carbon atoms. P¹ is not particularly limited as long as P¹ contains a hydrocarbon group having 8 or more carbon atoms, and examples thereof include at least one group selected from an aliphatic hydrocarbon group having 8 or more carbon atoms, an aryl group having 8 or more carbon atoms, a polyvinyl residue including a hydrocarbon group having 8 or more carbon atoms, a poly(meth)acrylic residue including a hydrocarbon group having 8 or more carbon atoms, a polyester residue including a hydrocarbon group having 8 or more carbon atoms, a polyamide residue including a hydrocarbon group having 8 or more carbon atoms, a fluorinated polyvinyl residue including a hydrocarbon group having 8 or more carbon atoms, a fluorinated poly(meth)acrylic residue including a hydrocarbon group having 8 or more carbon atoms, a fluorinated polyester residue including a hydrocarbon group having 8 or more carbon atoms, and a fluorinated polyamide residue including a hydrocarbon group having 8 or more carbon atoms.

Meanwhile, a polyvinyl residue, a poly(meth)acrylic residue, a polyester residue, a polyamide residue, a fluorinated polyvinyl residue, a fluorinated poly(meth)acrylic residue, a fluorinated polyester residue, and a fluorinated polyamide residue are also collectively referred to as resin residues.

In a case in which m is 2 or more in General Formula (1), two or more P¹'s may be identical to or different from each other.

Examples of the aliphatic hydrocarbon group having 8 or more carbon atoms include alkyl groups having 8 or more carbon atoms, alkenyl groups having 8 or more carbon atoms, alkynyl groups having 8 or more carbon atoms, groups formed of an unsaturated fatty acid residue having 8 or more carbon atoms, groups formed of a saturated fatty acid residue having 8 or more carbon atoms, and the like. Among the aliphatic hydrocarbon groups having 8 or more carbon atoms, alkyl groups having 8 or more carbon atoms, saturated fatty acid residues having 8 or more carbon atoms, and unsaturated fatty acid residues having 8 or more carbon atoms are preferred.

Examples of the alkyl groups having 8 or more carbon atoms include a normal octyl group, a 2-ethylhexyl group, a normal decyl group, a normal dodecyl group, a stearyl group, and the like. Alkyl groups having 8 to 50 carbon atoms are preferred, and alkyl groups having 8 to 30 carbon atoms are more preferred.

Examples of alkyl groups in the alkyl groups having 8 or more carbon atoms include an unsubstituted alkyl group, a fluorinated alkyl group, a cycloalkyl group, a fluorinated cycloalkyl group, and the like.

Examples of the groups formed of a saturated fatty acid residue having 8 or more carbon atoms include a caprylic acid residue, a pelargonic acid residue, a capric acid residue, a lauric acid residue, a myristic acid residue, a pentadecylic acid residue, a palmitic acid residue, a margaric acid residue, a stearic acid residue, an arachidic acid residue, a behenic acid residue, a lignoceric acid residue, a cerotic acid residue, a montanic acid residue, a melissic acid residue, and the like. Groups formed of a saturated fatty acid residue having 8 or more and less than 50 carbon atoms are preferred.

Examples of the groups formed of an unsaturated fatty acid residue having 8 or more carbon atoms include a palmitoleic acid residue, an oleic acid residue, a vaccenic acid residue, a linoleic acid residue, a (9,12,15)-linolenic acid residue, a (6,9,12)-linolenic acid residue, an eleostearic acid residue, a 8,11-eicosadienoic acid residue, a 5,8,11-eicosatrienoic acid residue, an arachidonic acid residue, and a nervonic acid residue. Groups formed of an unsaturated fatty acid residue having 8 or more and less than 50 carbon atoms are preferred.

Examples of the groups formed of a saturated fatty acid residue having 8 or more carbon atoms or the groups formed of an unsaturated fatty acid residue having 8 or more carbon atoms include groups formed by, for example, the dehydration condensation and esterification of a terminal hydroxyl group of the m+n-valent linking group represented by R¹ (for example, preferably specific example (18), specific example (19), or specific example (20) described above) and a saturated fatty acid or an unsaturated fatty acid having 8 or more carbon atoms.

Examples of saturated fatty acids having 8 or more carbon atoms include an octanoic acid, a nonanoic acid, a decanoic acid, an undecanoic acid, a dodecanoic acid (lauric acid), a tetradecanoic acid (myristric acid), a pentadecanoic acid, a hexadecanoic acid (palmitic acid), a heptadecanoic acid (margaric acid), an octadecanoic acid (stearic acid), an eicosanoic acid (arachidic acid), a docosanoic acid (behenic acid), a tetracosanoic acid (lignoceric acid), a hexacosanoic acid (cerotic acid), an octacosanoic acid (montanic acid), a triacontanoic acid (melissic acid), and the like.

Examples of unsaturated fatty acids having 8 or more carbon atoms include a 9-hexadecenoic acid (palmitoleic acid), a 9-octadecenoic acid (oleic acid), a 11-octadecenoic acid (vaccenic acid), a 9,12-octadecadienoic acid (linoleic acid), a 9,12,15-octadecanetrienoic acid (9,12,15-linolenic acid), a 6,9,12-octadecanetrienoic acid (6,9,12-linolenic acid), a 9,11,13-octadecanetrienoic acid (eleostearic acid), a 8,11-eicosadienoic acid, a 5,8,11-eicosatrienoic acid, a 5,8,11,14-eicosatetraenoic acid (arachidonic acid), a 15-tetracosanoic acid (nervonic acid), and the like.

The dehydration esterification between a hydroxyl group and a carboxylic acid can be obtained by transferring the equilibrium to ester compounds while removing water produced as a by-product during heating. Examples of the method for removing water include a method in which a Dean-Stark trap is used, a method in which a molecular sieve is mixed, a method in which water is volatilized outside the reaction system under a nitrogen stream, and the like.

The heating temperature in the dehydration ester reaction is preferably 160° C. or higher, more preferably 180° C. or higher, and still more preferably 200° C. or higher. In addition, a dehydration catalyst such as alkoxy titanium may be used.

Examples of the aryl group having 8 or more carbon atoms include a naphthyl group, a biphenyl group, a terphenyl group, an anthranyl group, a pyrenyl group, and the like. An aryl group having 8 or more and 50 or less carbon atoms is preferred, and an aryl group having 8 or more and 30 or less carbon atoms is more preferred. Examples of the aryl group include unsubstituted aryl groups, fluorinated aryl groups, and the like, and, among these, a naphthyl group and a biphenyl group are more preferred.

The resin residues having a hydrocarbon group having 8 or more carbon atoms may be residues of resins having a hydrocarbon main chain having 8 or more carbon atoms or residues of resins having a hydrocarbon group having 8 or more carbon atoms in a side chain.

The resins having a hydrocarbon main chain having 8 or more carbon atoms can be selected from well-known resins as long as the effects of the embodiment of the present invention are not impaired.

Examples of resins that can be used to form the resin residues having a hydrocarbon group having 8 or more carbon atoms include polymers or copolymers of vinyl monomers, ester-based polymers, ether-based polymers, urethane-based polymers, amide-based polymers, epoxy-based polymers, and modified substances or copolymers thereof [for example, polyether/polyurethane copolymers, copolymers of polymers of polyether/vinyl monomers (which may be any one of random copolymers, block copolymers, and graft copolymers)].

Among the resins, polymers or copolymers of vinyl monomers, ester-based polymers, and modified substances or copolymers thereof are preferred, and polymers or copolymers of vinyl monomers are more preferred.

These resins may be used singly or two or more resins may be jointly used.

In addition, the resins are preferably soluble in organic solvents and more preferably soluble in hydrocarbon solvents.

The vinyl monomers are not particularly limited, but are preferably, for example, (meth)acrylic acid esters, crotonic acid esters, vinyl esters, maleic acid diesters, fumaric acid diesters, itaconic acid diesters, (meth)acrylamides, styrene, vinyl ethers, vinyl ketones, olefins, maleimides, (meth)acrylonitrile, and vinyl monomers having an acidic group.

Hereinafter, preferred examples of these vinyl monomers will be described.

Examples of the (meth)acrylic acid esters include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, amyl (meth)acrylate, n-hexyl (meth)acrylate, cyclohexyl (meth)acrylate, t-butylcyclohexyl (meth)acrylate, 2-ethylhexyl (meth)acrylate, t-octyl (meth)acrylate, dodecyl (meth)acrylate, octadecyl (meth)acrylate, acetoxyethyl (meth)acrylate, phenyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, 2-methoxyethyl (meth)acrylate, 2-ethoxyethyl (meth)acrylate, 2-(2-methoxyethoxy)ethyl (meth)acrylate, 3-phenoxy-2-hydroxypropyl (meth)acrylate, 2-chloroethyl (meth)acrylate, glycidyl (meth)acrylate, 3,4-epoxycyclohexylmethyl (meth)acrylate, vinyl (meth)acrylate, 2-phenylvinyl (meth)acrylate, 1-propenyl (meth)acrylate, allyl (meth)acrylate, 2-allyloxyethyl (meth)acrylate, propargyl (meth)acrylate, benzyl (meth)acrylate, diethylene glycol monomethyl ether (meth)acrylate, diethylene glycol monoethyl ether (meth)acrylate, triethylene glycol monomethyl ether (meth)acrylate, triethylene glycol monoethyl ether (meth)acrylate, polyethylene glycol monomethyl ether (meth)acrylate, polyethylene glycol monoethyl ether (meth)acrylate, β-phenoxyethoxyethyl (meth)acrylate, nonylphenoxypolyethylene glycol (meth)acrylate, dicyclopentenyl (meth)acrylate, dicyclopentenyloxyethyl (meth)acrylate, trifluoroethyl (meth)acrylate, octafluoropentyl (meth)acrylate, perfluorooctylethyl (meth)acrylate, dicyclopentanyl (meth)acrylate, tribromophenyloxyethyl (meth)acrylate, tribromophenyloxyethyl (meth)acrylate, γ-butyrolactone (meth)acrylate, and the like.

Examples of the crotonic acid esters include butyl crotonate, hexyl crotonate, and the like.

Examples of the vinyl esters include vinyl acetate, vinyl chloroacetate, vinyl propionate, vinyl butyrate, vinyl methoxyacetate, vinyl benzoate, and the like.

Examples of the maleic acid diesters include dimethyl maleate, diethyl maleate, dibutyl maleate, and the like.

Examples of the fumaric acid diesters include dimethyl fumarate, diethyl fumarate, dibutyl fumarate, and the like.

Examples of the itaconic acid diesters include dimethyl itaconate, diethyl itaconate, dibutyl itaconate, and the like.

Examples of the (meth)acrylamides include (meth)acrylamide, N-methyl (meth)acrylamide, N-ethyl (meth)acrylamide, N-propyl (meth)acrylamide, N-isopropyl (meth)acrylamide, N-n-butyl (meth)acrylamide, N-t-butyl (meth)acrylamide, N-cyclohexyl (meth)acrylamide, N-(2-methoxyethyl) (meth)acryl amide, N,N-dimethyl (meth)acrylamide, N,N-diethyl (meth)acrylamide, N-phenyl (meth)acrylamide, N-nitrophenyl acrylamide, N-ethyl-N-phenyl acryl amide, N-benzyl (meth)acrylamide, (meth)acryloyl morpholine, diacetone acrylamide, N-methylol acrylamide, N-hydroxyethyl acrylamide, vinyl (meth)acrylamide, N,N-diallyl (meth)acrylamide, N-allyl (meth)acrylamide, and the like.

Examples of the styrene include styrene, methylstyrene, dimethylstyrene, trimethyl styrene, ethyl styrene, isopropyl styrene, butyl styrene, hydroxystyrene, methoxystyrene, butoxystyrene, acetoxystyrene, chlorostyrene, dichlorostyrene, bromostyrene, chloromethylstyrene, hydroxystyrene protected with a group that can be deprotected by an acidic substance (for example, t-Boc or the like), methyl vinyl benzoate, α-methylstyrene, and the like.

Examples of the vinyl ethers include methyl vinyl ether, ethyl vinyl ether, 2-chloroethyl vinyl ether, hydroxyethyl vinyl ether, propyl vinyl ether, butyl vinyl ether, hexyl vinyl ether, octyl vinyl ether, methoxyethyl vinyl ether, phenyl vinyl ether, and the like.

Examples of the vinyl ketones include methyl vinyl ketone, ethyl vinyl ketone, propyl vinyl ketone, phenyl vinyl ketone, and the like.

Examples of the olefins include ethylene, propylene, isobutylene, butadiene, isoprene, and the like.

Examples of the maleimides include maleimide, butyl maleimide, cyclohexyl maleimide, phenyl maleimide, and the like.

(Meth)acrylonitrile, heterocyclic groups substituted with a vinyl group (for example, vinyl pyridine, N-vinyl pyrrolidone, and vinyl carbazole), N-vinyl formamide, N-vinyl acetamide, N-vinyl imidazole, vinyl caprolactone, and the like can also be used.

In addition to the above-described compounds, for example, vinyl monomers having a functional group of a urethane group, a urea group, a sulfonamide group, a phenol group, or an imide group can also be used. The vinyl monomers having a urethane group or urea group can be appropriately synthesized using, for example, an addition reaction between an isocyanate group and a hydroxyl group or amino group.

Specifically, the vinyl monomers having a urethane group or urea group can be appropriately synthesized using an addition reaction between an isocyanate group-containing monomer and a compound containing one hydroxyl group or a compound containing one primary or secondary amino group, an addition reaction between a hydroxyl group-containing monomer or a primary or secondary amino group-containing monomer and monoisocyanate, or the like.

Examples of the vinyl monomers having an acidic group include vinyl monomers having a carboxyl group, vinyl monomers having a sulfonic acid group, vinyl monomers containing a phenolic hydroxyl group, vinyl monomers containing a sulfonamide group, and the like.

Examples of the vinyl monomers having a carboxyl group include (meth)acrylic acid, vinyl benzoic acid, maleic acid, monoalkyl maleic acid esters, fumaric acid, itaconic acid, crotonic acid, cinnamic acid, acrylic acid dimers, and the like. In addition, examples thereof also include addition reaction products between a monomer having a hydroxyl group such as 2-hydroxyethyl (meth)acrylate and a cyclic anhydride such as a maleic anhydride, a phthalic anhydride, or a cyclohexanedicarboxylic anhydride, ω-carboxy-polycaprolactone mono(meth)acrylate, and the like. In addition, as a precursor of a carboxyl group, a maleic anhydride, an itaconic anhydride, or a citraconic anhydride may also be used. Meanwhile, among these, (meth)acrylic acid is particularly preferred from the viewpoint of co-polymerizability, costs, solubility, and the like.

Examples of the vinyl monomers having a sulfonic acid group include 2-acrylamide-2-methylpropane sulfonic acid, and the like.

Examples of vinyl monomers having a phosphoric acid group include mono(2-acryloyloxyethyl ester) phosphate, mono(1-methyl-2-acryloyloxyethyl ester) phosphate, and the like.

From the viewpoint of an effect of suppressing the deterioration due to moisture and oxidation and reduction deterioration of the inorganic solid electrolyte and an effect of dispersion stability being excellent, the resin residues having a hydrocarbon group having 8 or more carbon atoms are preferably residues of the polymers or copolymers of vinyl monomers, residues of the ester-based polymers, residues of amide-based polymers, residues of ether-based polymers, residues of urethane-based polymers, or residues of epoxy-based polymers and more preferably polyvinyl residues including a hydrocarbon group having 8 or more carbon atoms, poly(meth)acrylic residues including a hydrocarbon group having 8 or more carbon atoms, polyester residues including a hydrocarbon group having 8 or more carbon atoms, polyamide residues including a hydrocarbon group having 8 or more carbon atoms, fluorinated polyvinyl residues including a hydrocarbon group having 8 or more carbon atoms, fluorinated poly(meth)acrylic residues including a hydrocarbon group having 8 or more carbon atoms, fluorinated polyester residues including a hydrocarbon group having 8 or more carbon atoms, and fluorinated polyamide residues including a hydrocarbon group having 8 or more carbon atoms.

From the viewpoint of an effect of suppressing the deterioration due to moisture and oxidation and reduction deterioration of the inorganic solid electrolyte, P¹ is more preferably an aliphatic hydrocarbon group having 8 or more carbon atoms and still more preferably a group formed of a saturated fatty acid residue having 8 or more and less than 50 carbon atoms or an unsaturated fatty acid residue having 8 or more and less than 50 carbon atoms.

From the viewpoint of an effect of suppressing the deterioration due to moisture and oxidation and reduction deterioration of the inorganic solid electrolyte, the formula weight of the group represented by P¹ is preferably 200 or more and less than 100,000, more preferably 200 or more and 10,000 or less, and still more preferably 200 or more and 3,000 or less.

The formula weight can be obtained by drawing a figure of a group corresponding to P¹ on the basis of the chemical formula using ChemBloDraw Ultra 12.0.2 and calculating the formula weight.

In General Formula (1), m represents 1 to 8. m is preferably 1 to 5, more preferably 2 to 5, still more preferably 2 to 4, and particularly preferably 2 or 3.

In addition, in General Formula (1), n represents 1 to 9. n is preferably 2 to 8, more preferably 2 to 7, still more preferably 2 to 4, and particularly preferably 3 or 4.

m+n satisfies 3 to 10. Among these, m+n is preferably 4 to 6 and more preferably 6.

In General Formula (1), in a combination of m and n, it is preferable that m is 2 to 5 and n is 2 to 4.

The compound represented by General Formula (1) is preferably a compound represented by General Formula (2) from the viewpoint of dispersion stability during synthesis.

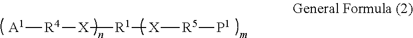

In General Formula (2), R¹, A¹, P¹, n, and m are the same as R¹, A¹, P¹, n, and m in General Formula (1), and preferred ranges thereof are also identical.

In General Formula (2), R⁴'s each independently represent a single bond or a divalent linking group. In a case in which n is 2 or more, two or more R⁴'s may be identical to or different from each other. The divalent linking group is the same as the divalent linking group represented by R² in General Formula (1).

In General Formula (2), R⁵'s each independently represent a single bond or a divalent linking group. In a case in which m is 2 or more, two or more R⁵'s may be identical to or different from each other. The divalent linking group is the same as the divalent linking group represented by R² in General Formula (1).

In General Formula (2), X represents an oxygen atom or a sulfur atom. From the viewpoint of the dispersion stability of the solid electrolyte composition, X is preferably a sulfur atom.

More preferred aspects of the compound represented by General Formula (2) include aspects in which all of R¹, R⁴, R⁵, P¹, m, and n described below are satisfied.

R¹: specific example (1), specific example (2), specific example (10), specific example (11), specific example (16), or specific example (17)

R⁴: A single bond or a linking group formed of any one of structural units described below or a combination of two or more structural units described below

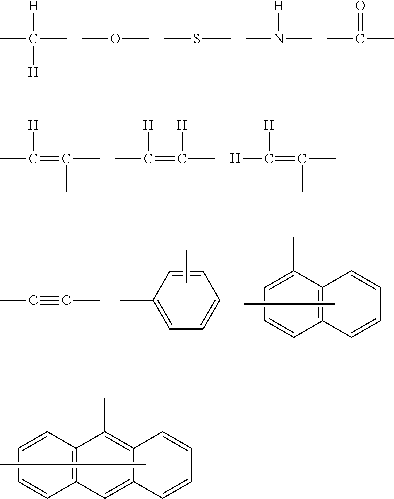

R⁵: A single bond, an ethylene group, a propylene group, a group (a) described below, or a group (b) described below

Meanwhile, in the following group, R²⁵ represents a hydrogen atom or a methyl group, and 1 represents 1 or 2.

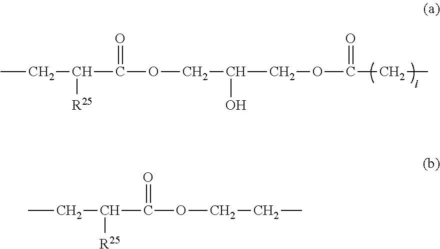

P¹: A residue of a homopolymer or copolymer of a vinyl monomer, an ester-based polymer residue, or a residue of a modified substance thereof

m: 1 to 5

n: 1 to 5

The weight-average molecular weight of the compound represented by General Formula (1) is not particularly limited; however, from the viewpoint of the dispersion stability of the solid electrolyte composition, the weight-average molecular weight is preferably 600 or more and less than 200,000, more preferably 600 or more and 100,000 or less, still more preferably 600 or more and 50,000 or less, particularly preferably 800 or more and 20,000 or less, and most preferably 100 or more and 10,000 or less.

Meanwhile, the weight-average molecular weight can be measured using the method described above.

(Synthesis Method)

The method for synthesizing the compound represented by General Formula (1) is not particularly limited, and the compound can be synthesized using, for example, methods 1) to 5) below.

1) A method in which a polymer reaction is caused between a polymer having a group selected from a carboxyl group, a hydroxyl group, and an amino group introduced into a terminal and an acid halide having a plurality of adsorption groups, an alkyl halide having a plurality of adsorption groups, or isocyanate having a plurality of adsorption groups

2) A method in which a Michael addition reaction is caused between a polymer having a carbon-carbon double bond introduced into a terminal and mercaptan having a plurality of adsorption groups

3) A method in which a reaction is caused between a polymer having a carbon-carbon double bond introduced into a terminal and mercaptan having an adsorption group in the presence of a radical-generating agent

4) A method in which a reaction is caused between a polymer having a plurality of mercaptan introduced into a terminal and a compound having a carbon-carbon double bond and an adsorption group in the presence of a radical-generating agent

5) A method in which the radical polymerization of vinyl monomers is caused in the presence of a mercaptan compound having a plurality of adsorption groups

Regarding more specific synthesis methods, Paragraphs 0103 to 0133 of JP5553957B can be referred to.

Hereinafter, exemplary compounds of the compound represented by General Formula (1) will be illustrated, but the embodiment of the present invention is not limited thereto.

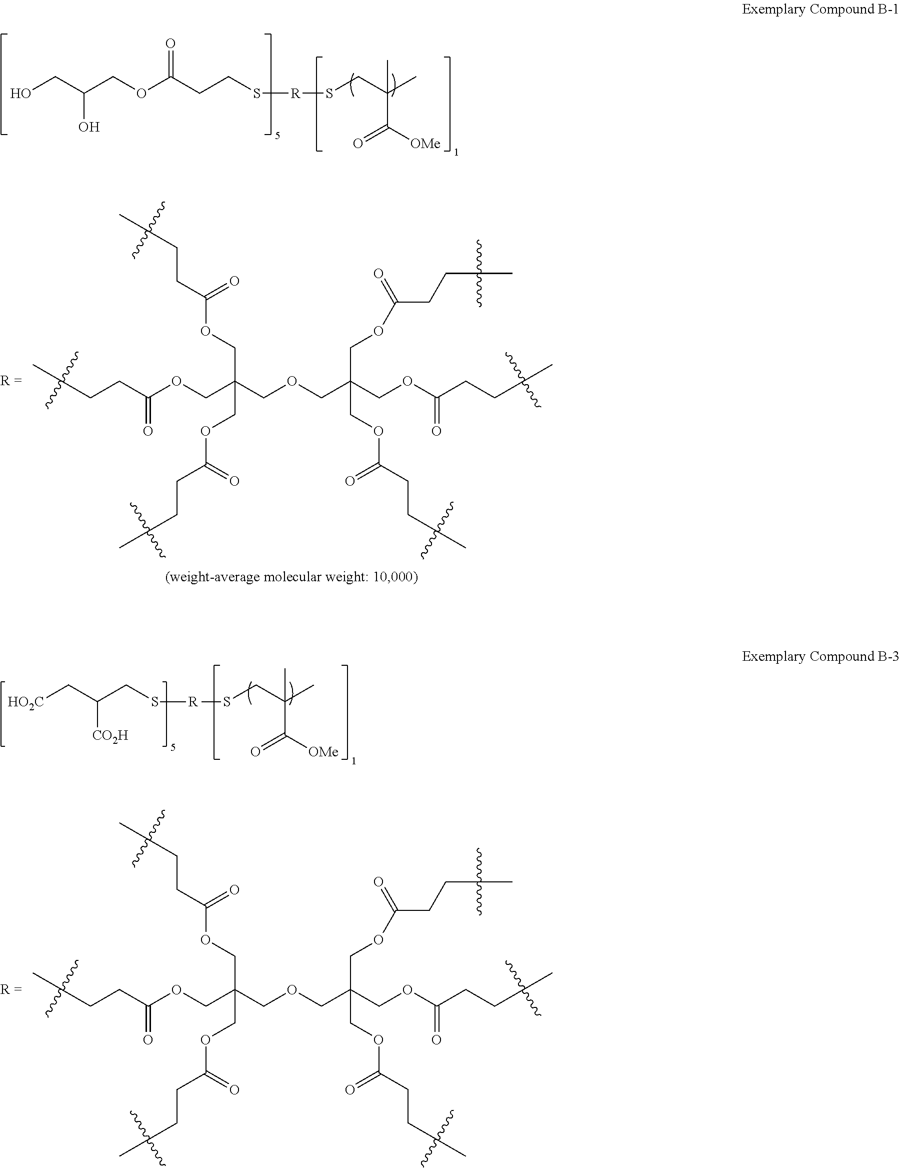

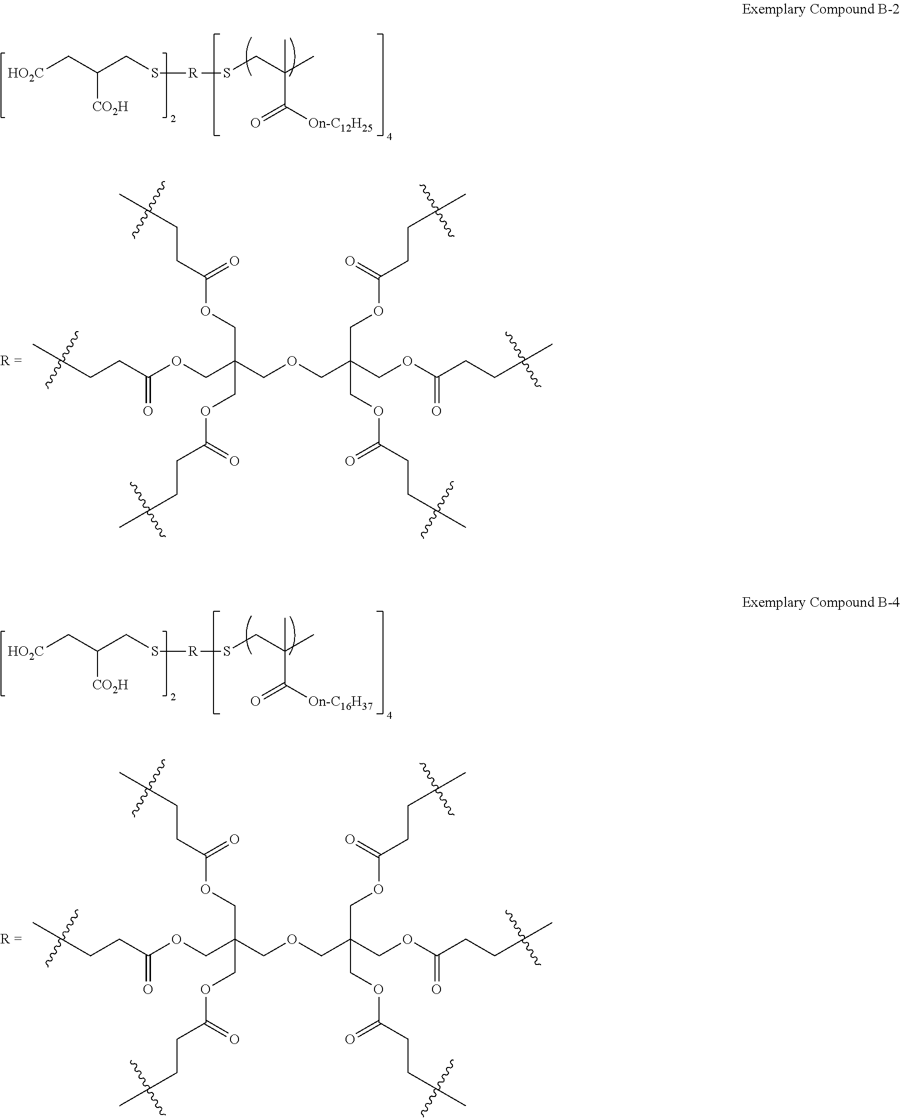

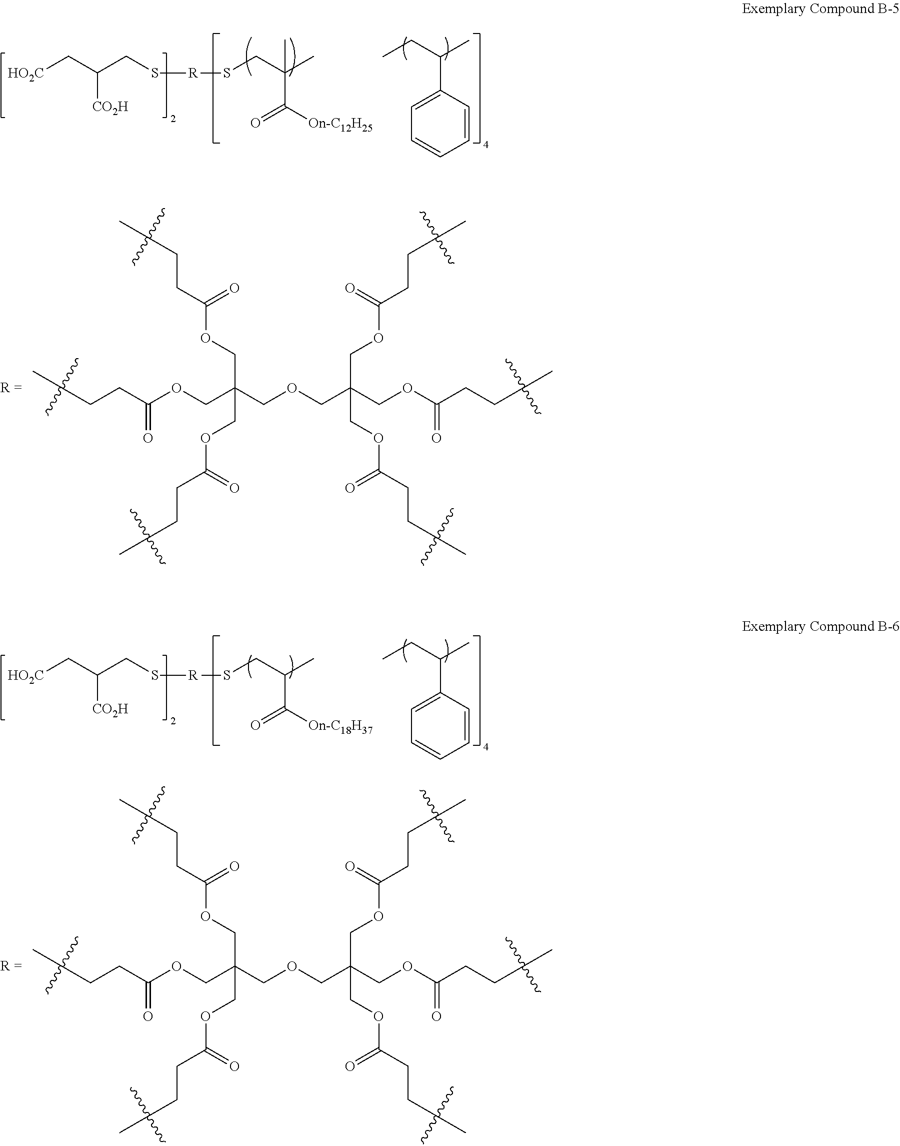

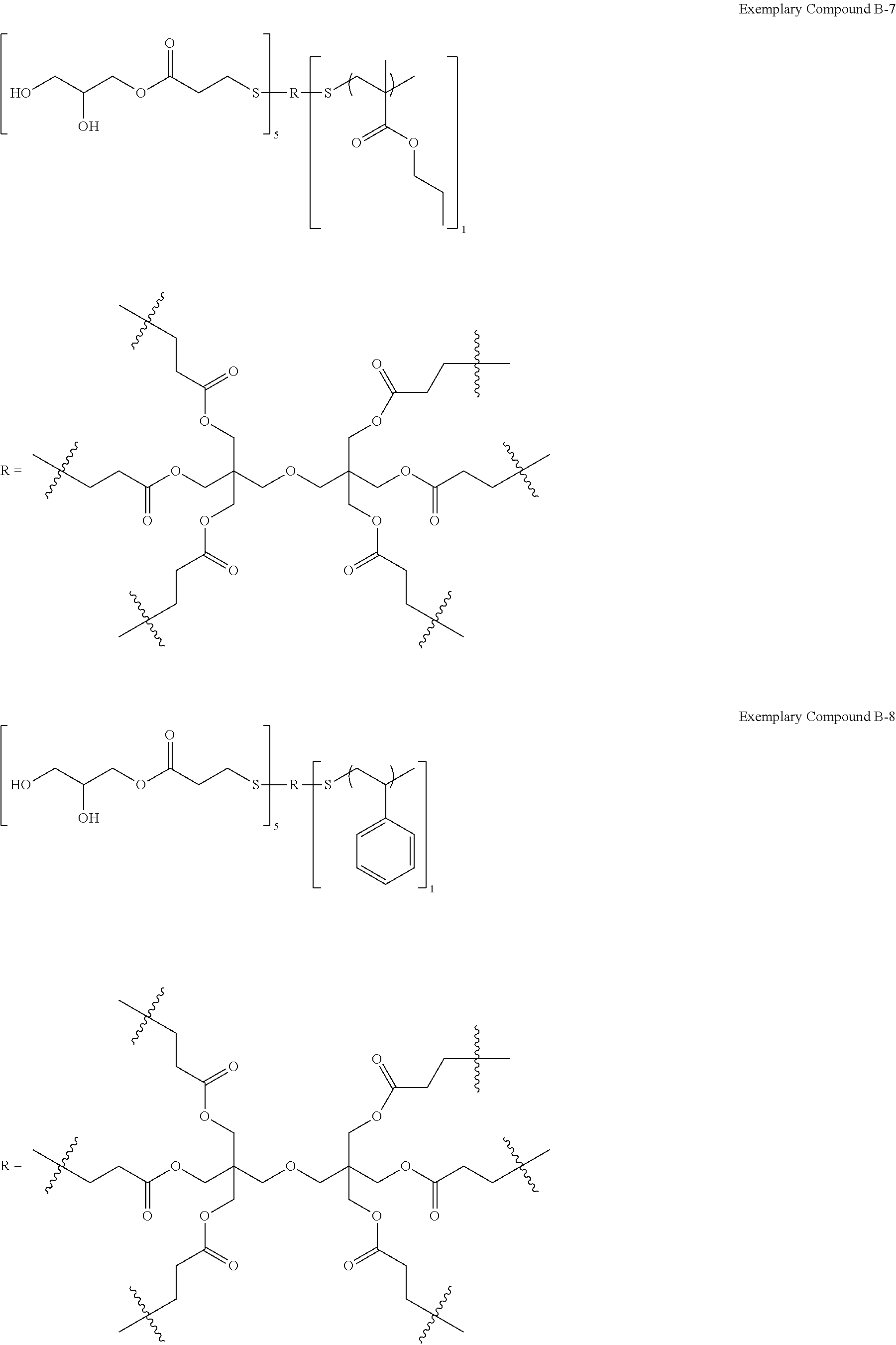

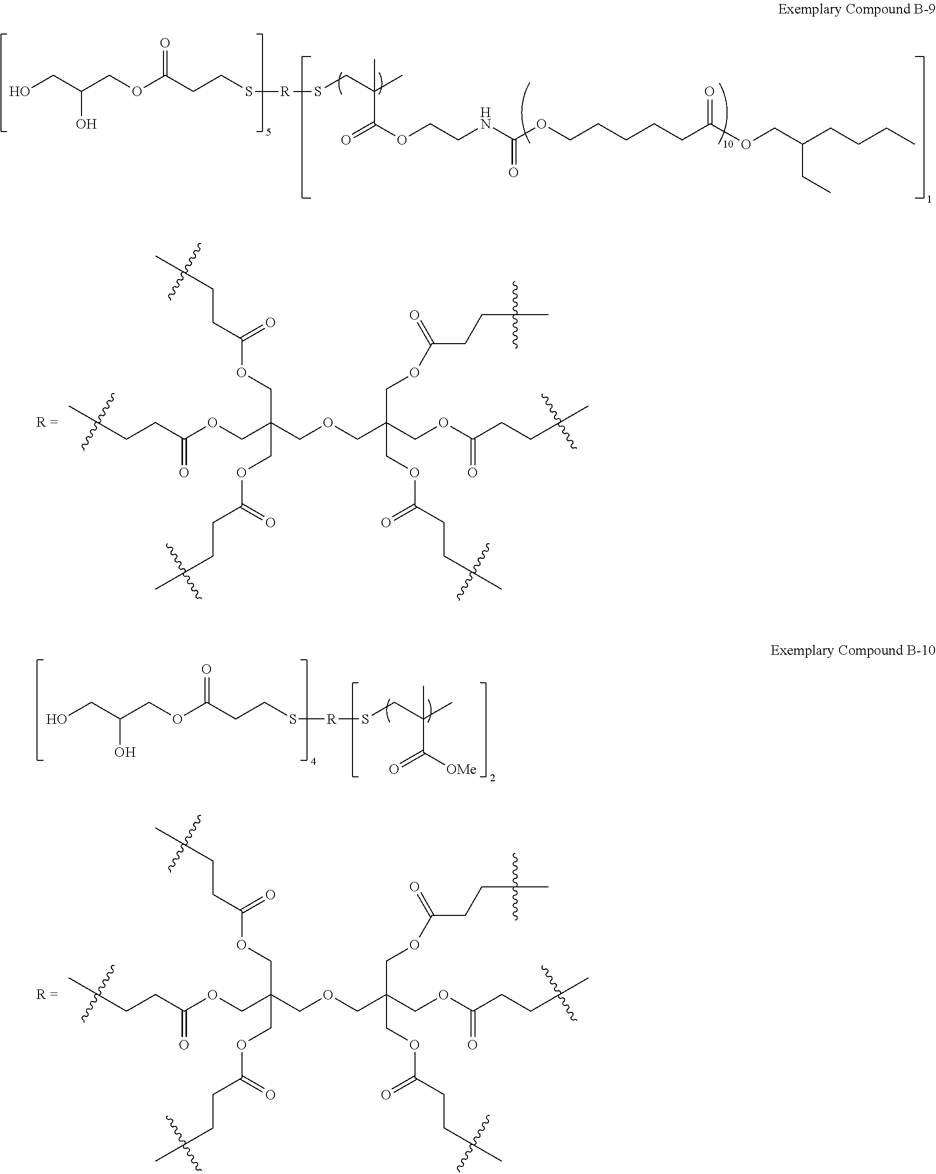

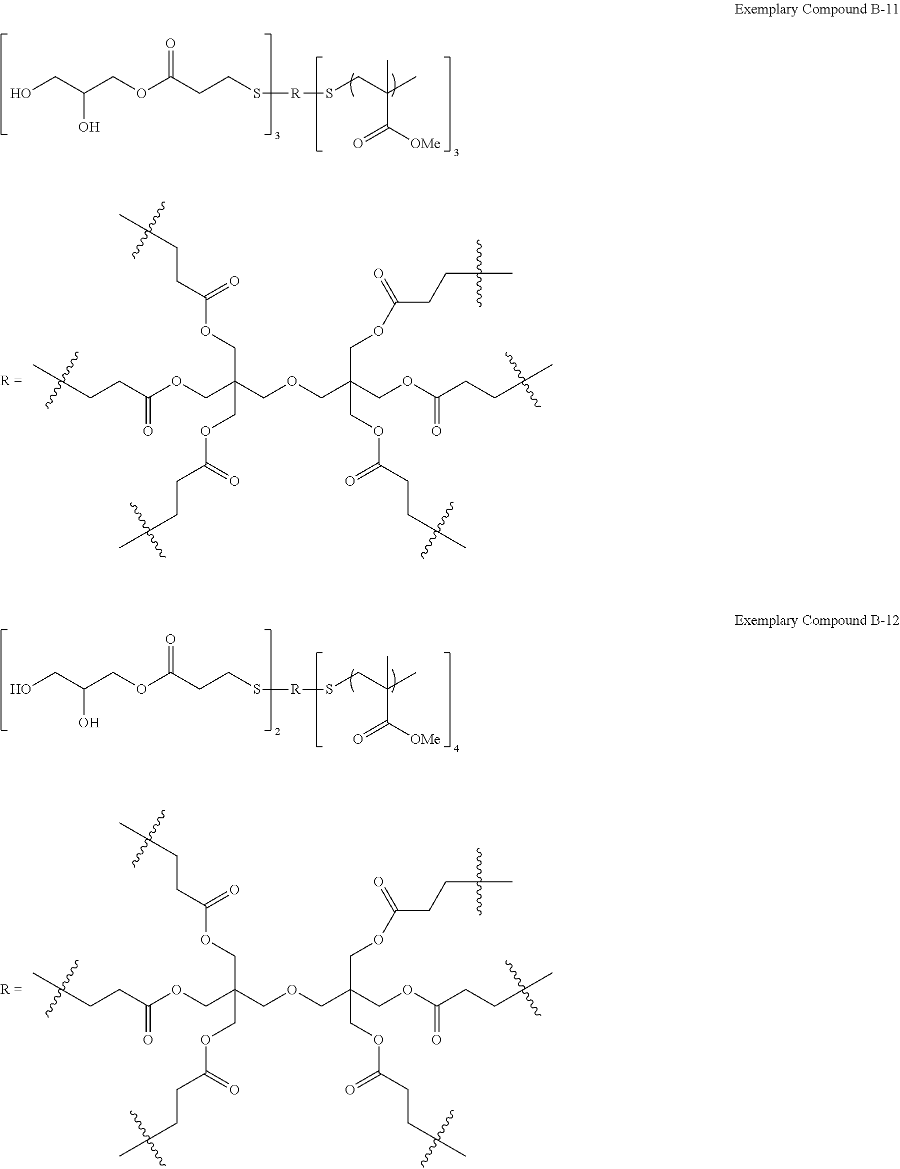

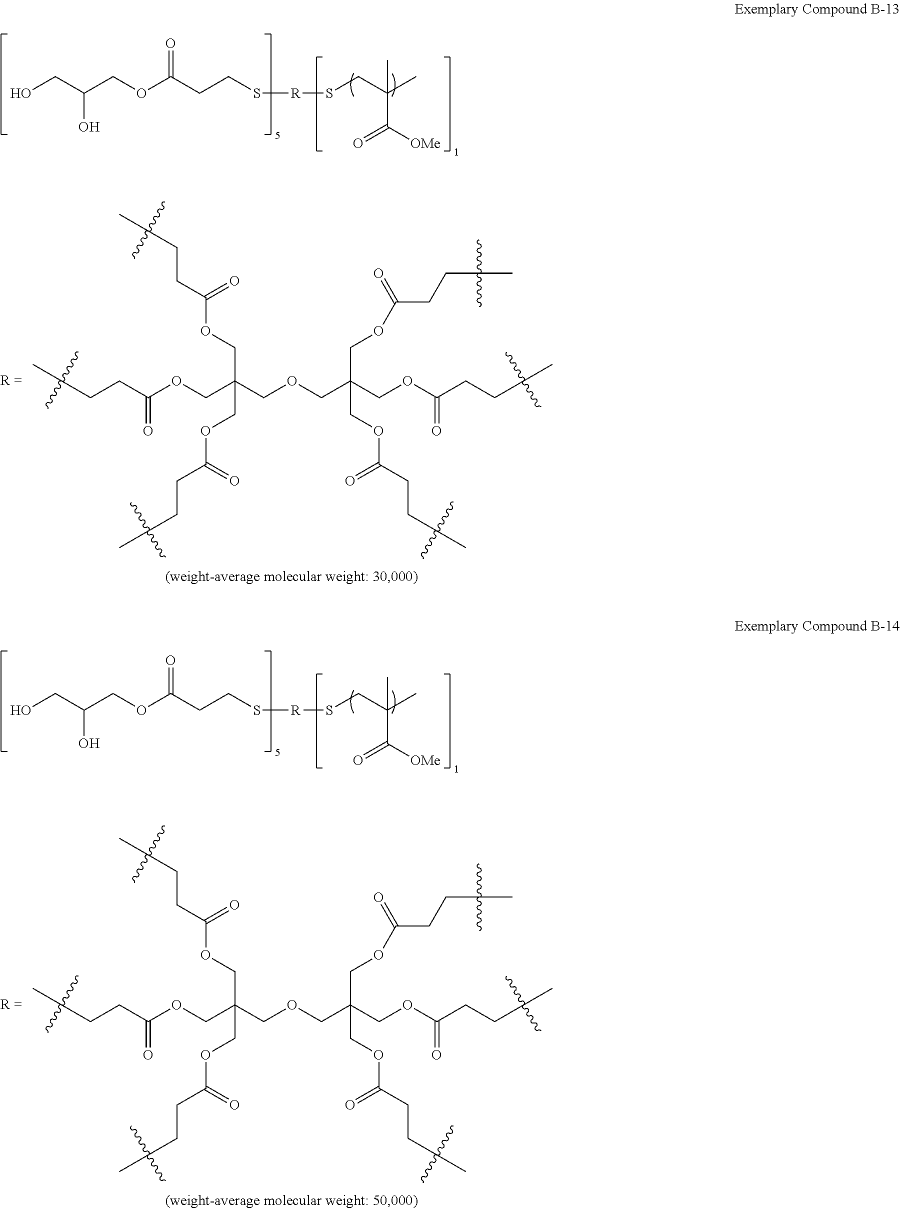

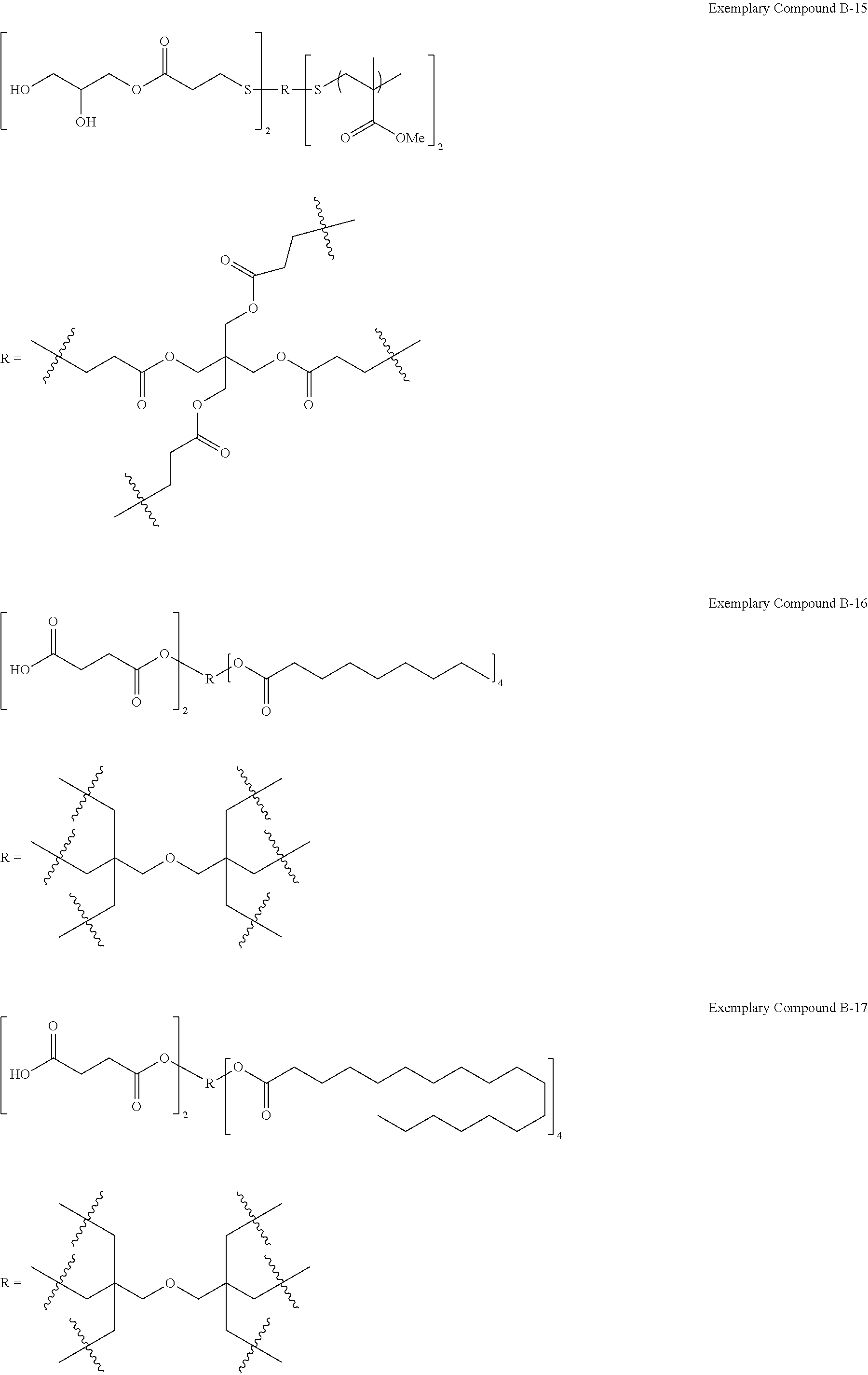

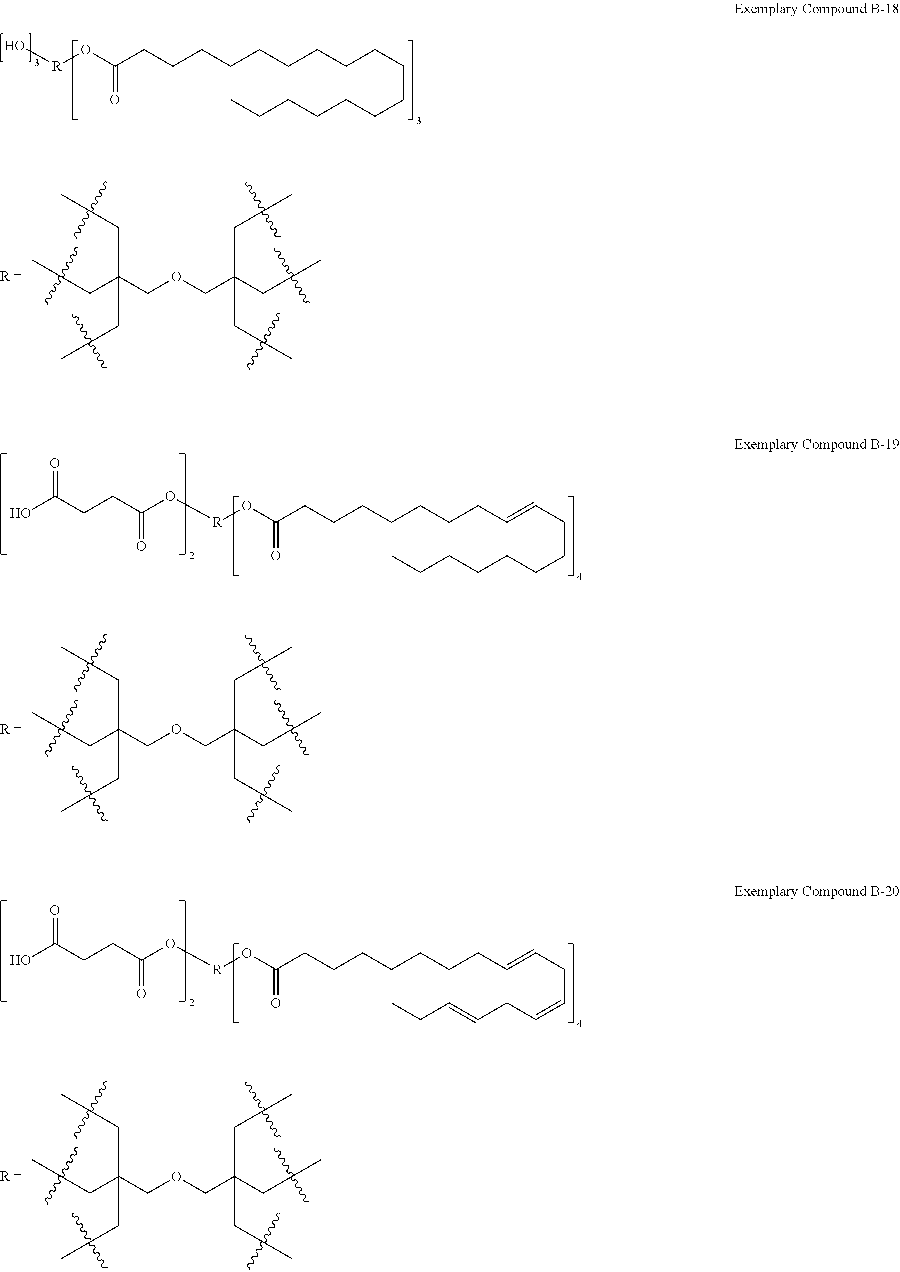

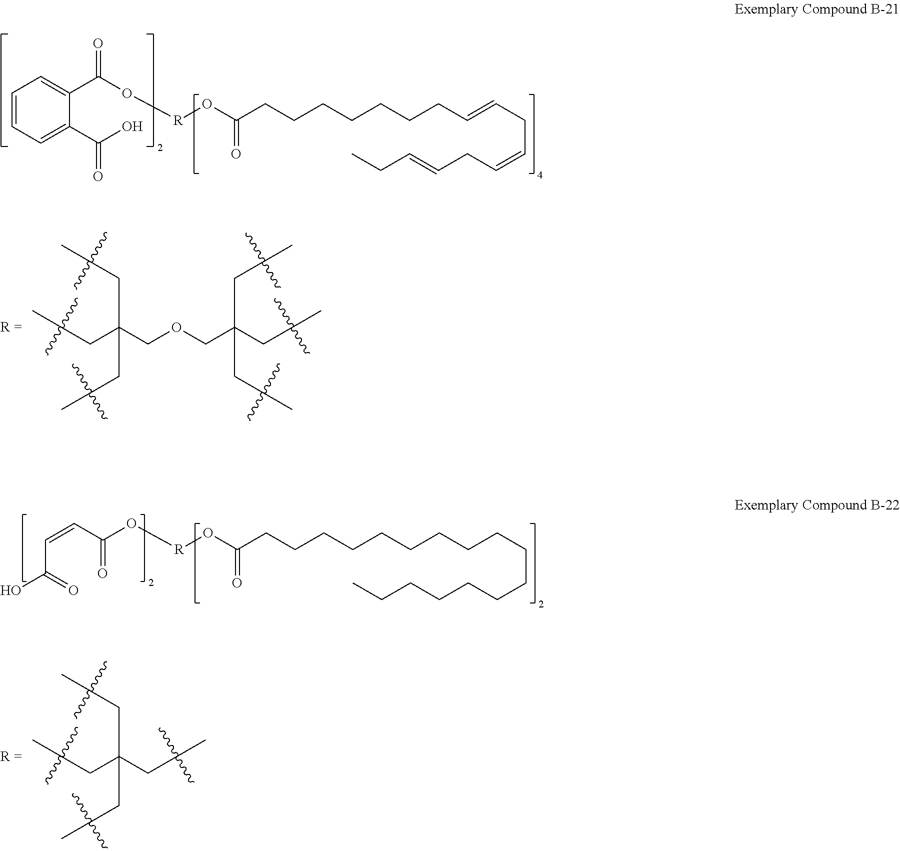

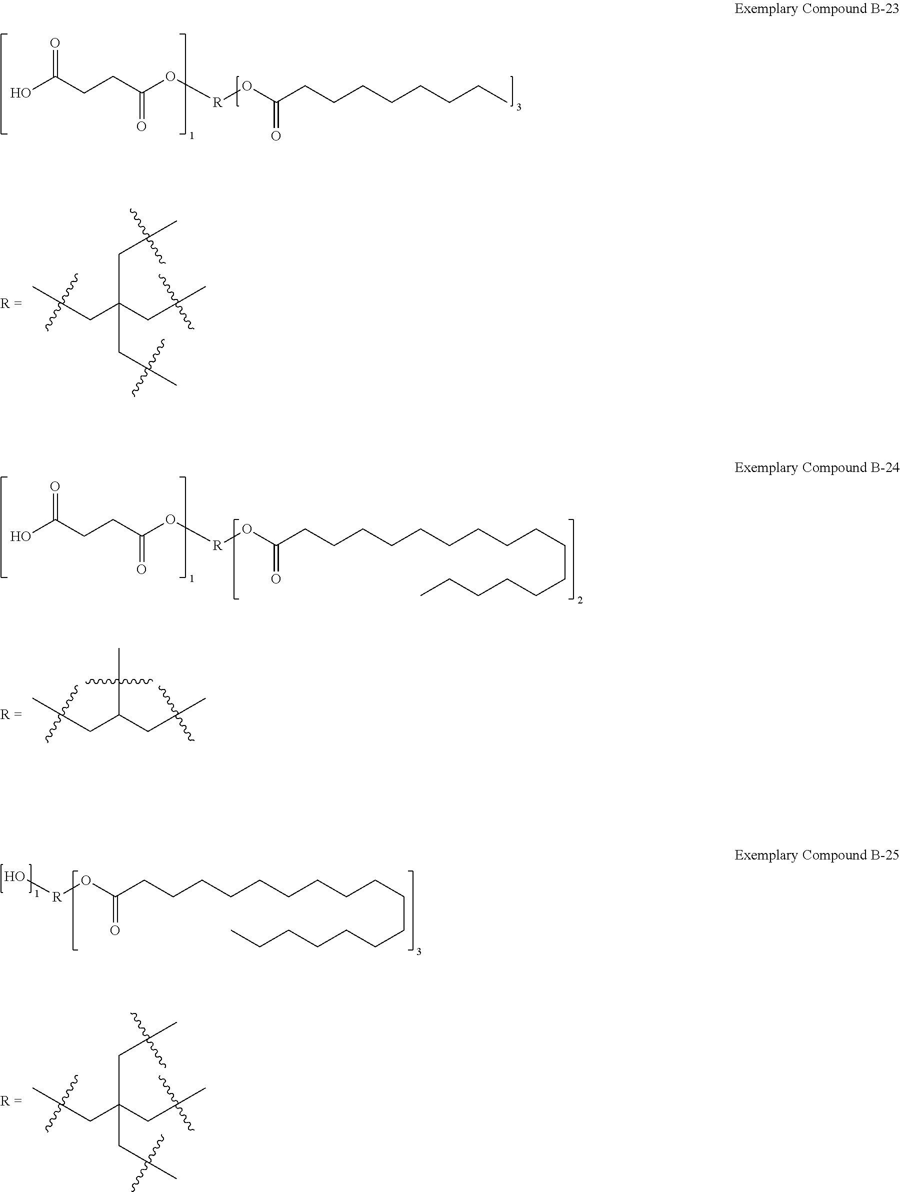

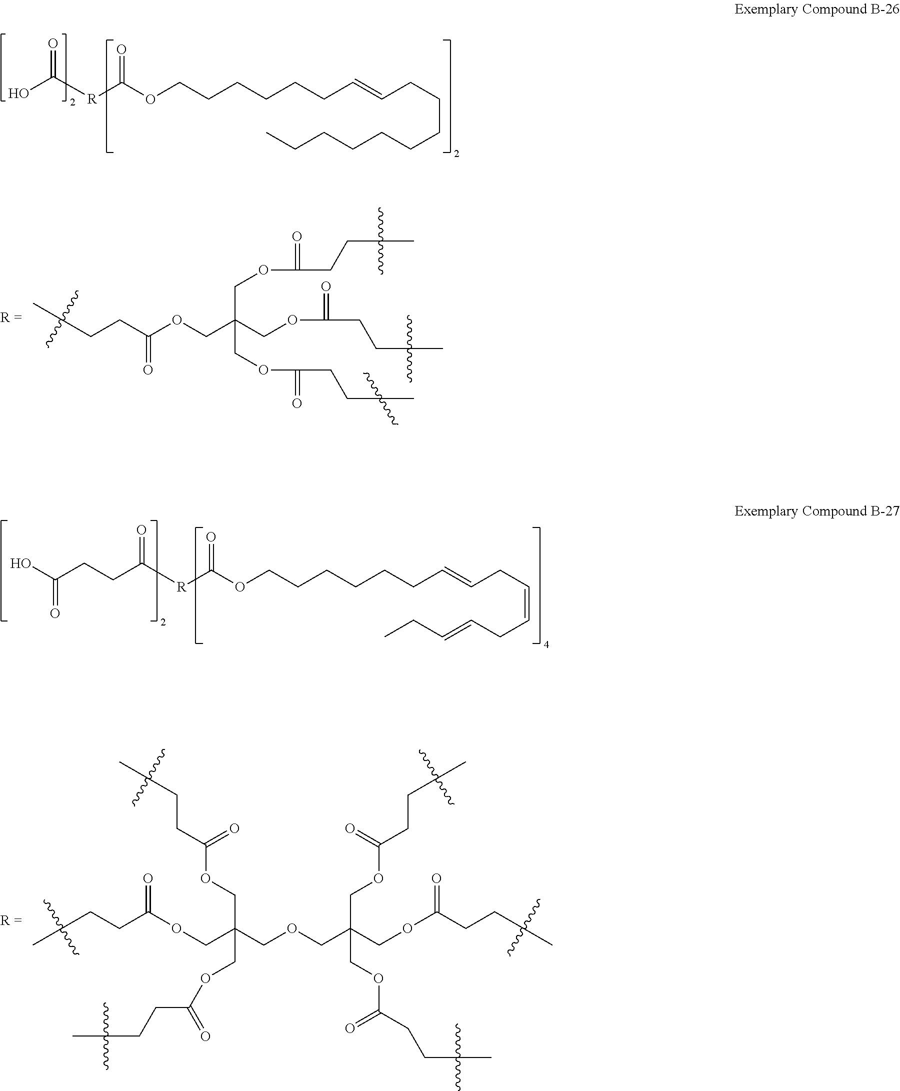

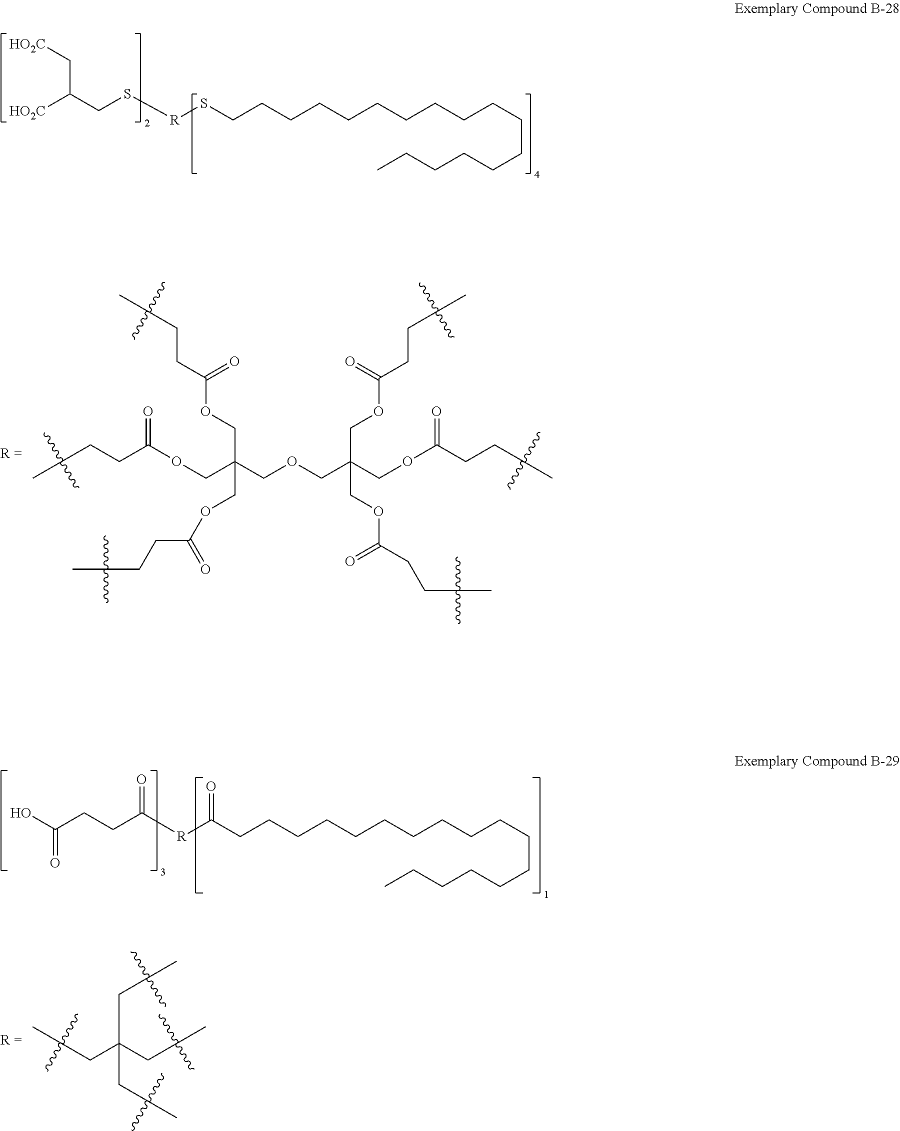

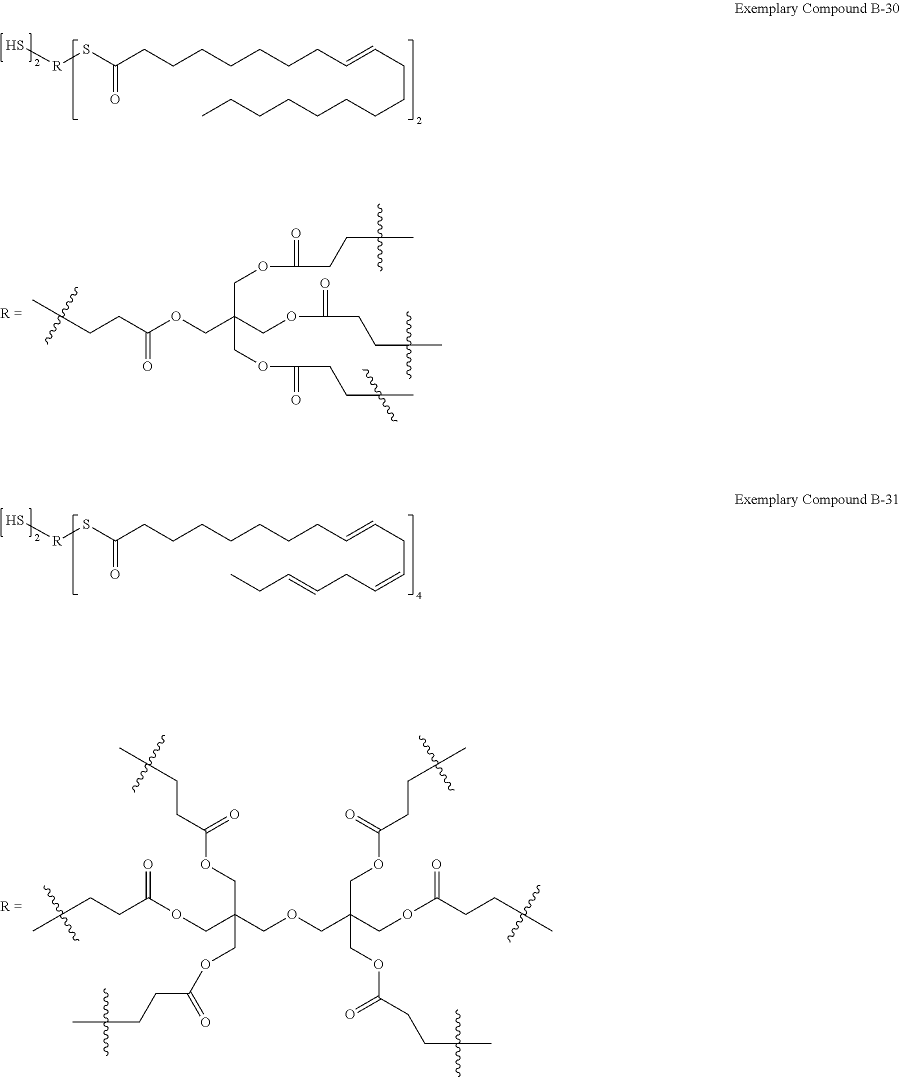

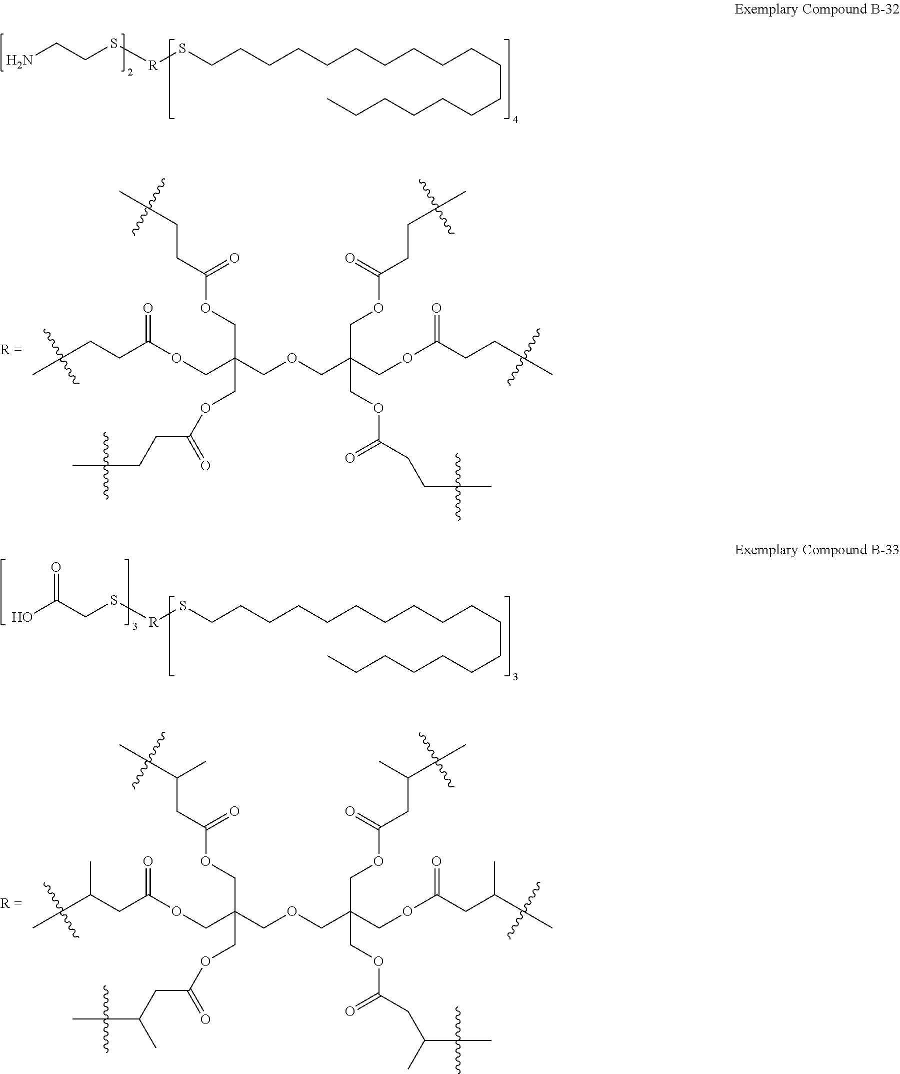

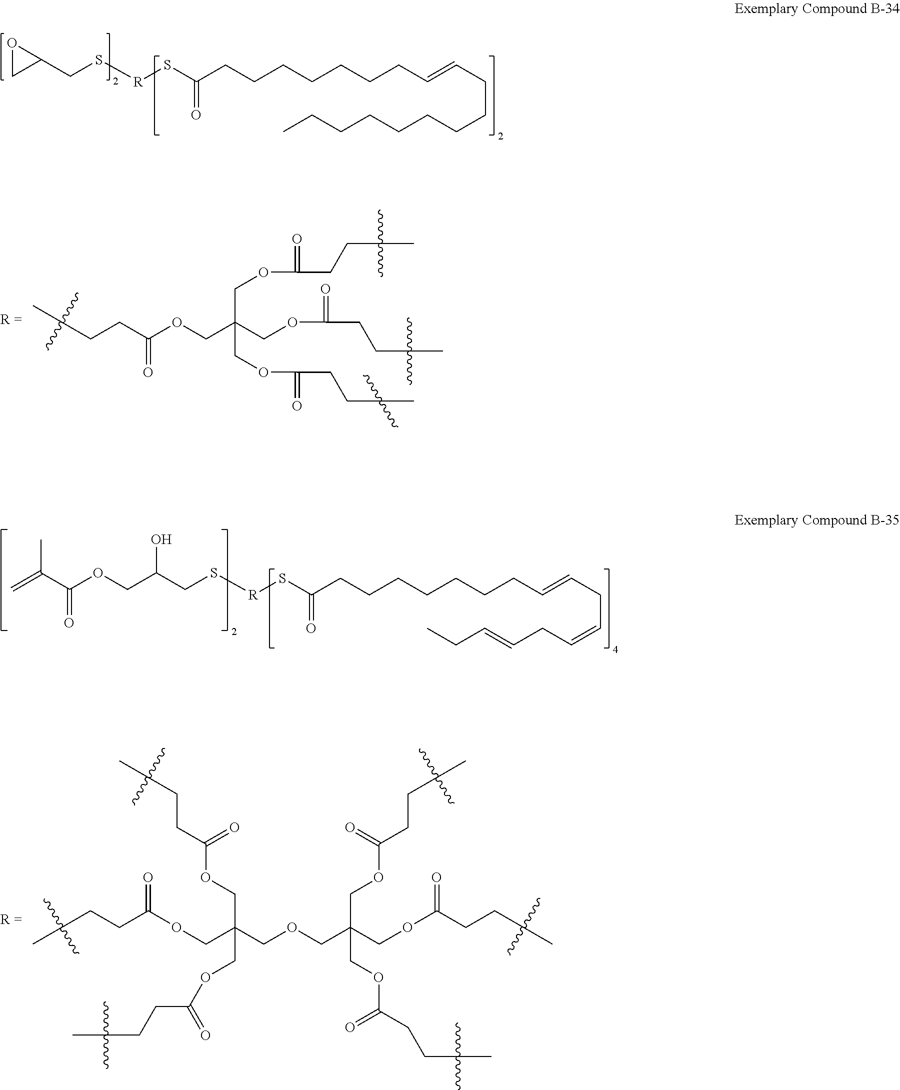

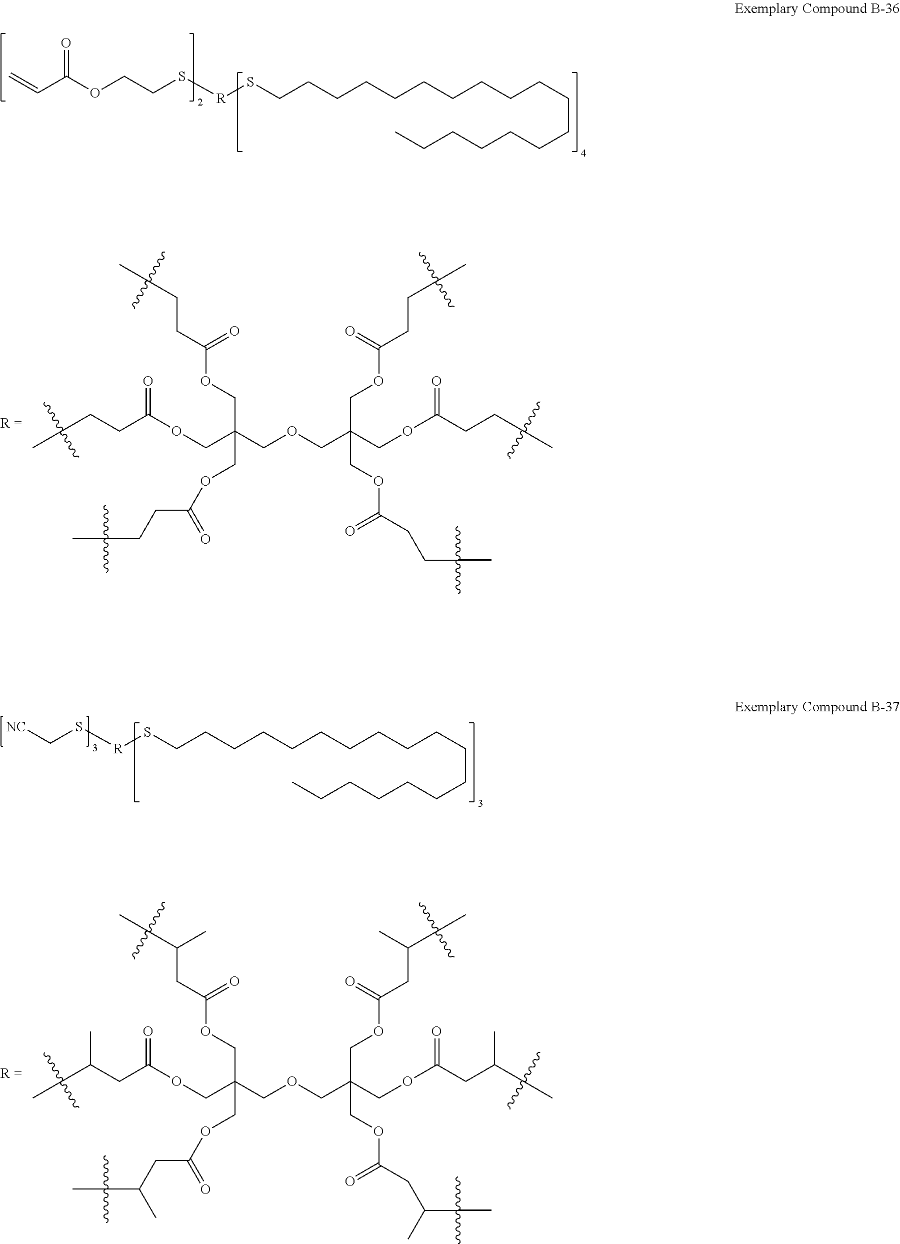

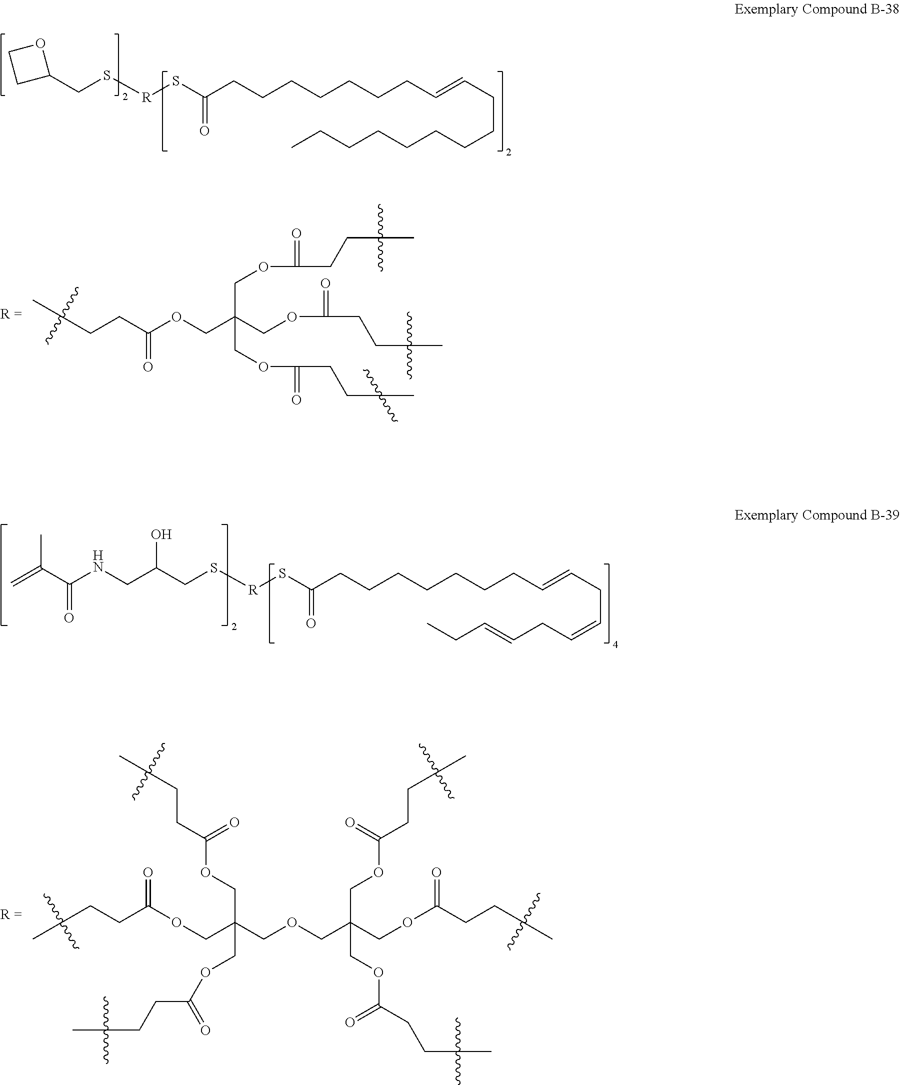

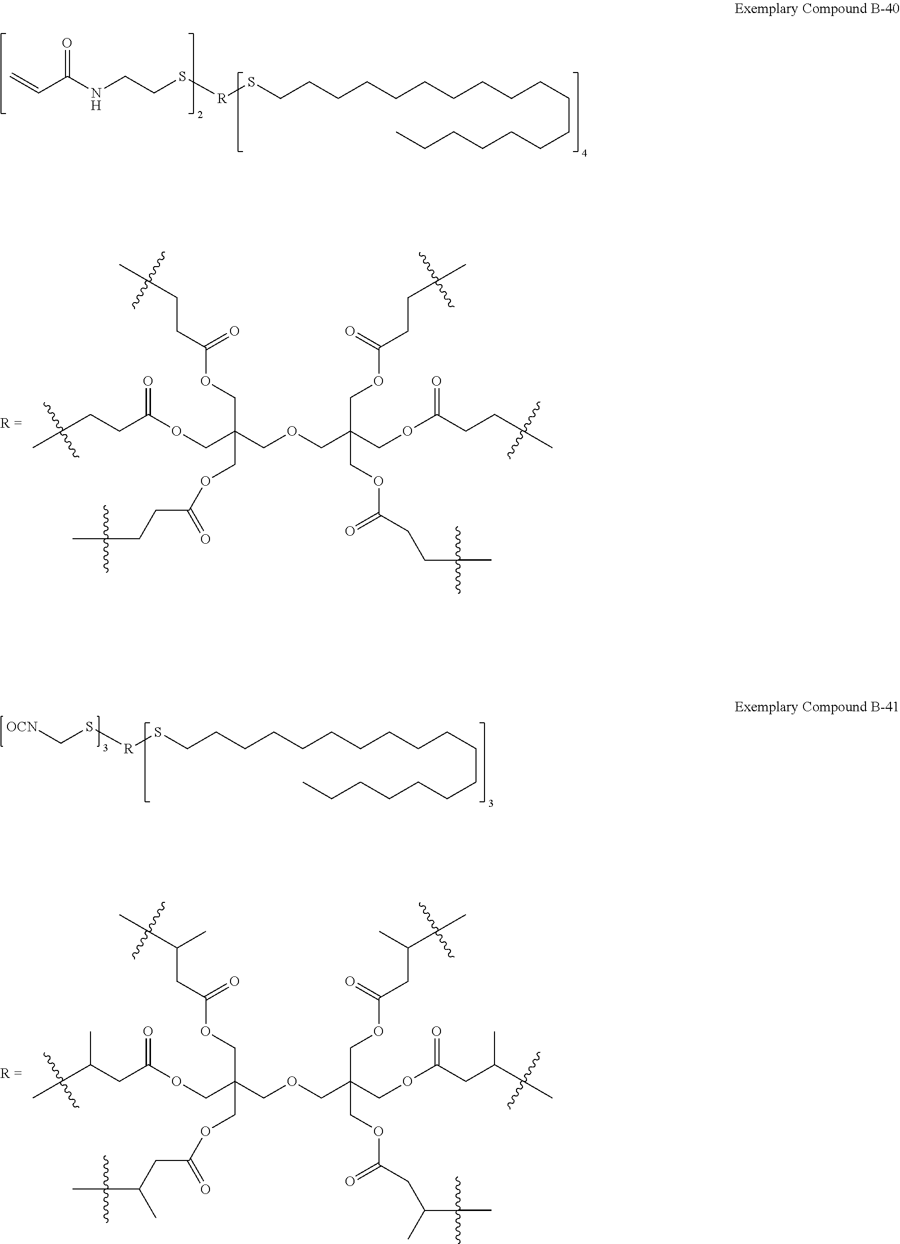

The content of the compound represented by General Formula (1) in the solid electrolyte composition is preferably 0.01 parts by mass or more, more preferably 0.1 parts by mass or more, and still more preferably 0.5 parts by mass or more with respect to 100 parts by mass of the inorganic solid electrolyte (including the active material in the case of being used). The upper limit is preferably 20 parts by mass or less, more preferably 15 parts by mass or less, and still more preferably 10 parts by mass or less.

The content of the compound represented by General Formula (1) is preferably 0.01% by mass or more, more preferably 0.1% by mass or more, and still more preferably 0.5% by mass or more of the total solid content of the solid electrolyte composition. The upper limit is preferably 20% by mass or less, more preferably 15% by mass or less, and still more preferably 10% by mass or less.

When the content of the compound represented by General Formula (1) is in the above-described range, it is possible to more effectively develop an effect of suppressing the deterioration due to moisture and oxidation and reduction deterioration of the inorganic solid electrolyte.

[Binder (C)]

In addition to the exemplary compound of the embodiment of the present invention, an arbitrary binder may be added to the solid electrolyte composition. The binder enhances the bonding properties to the active materials and the inorganic solid electrolyte. As the binder, for example, fluorine-based polymers (polytetrafluoroethylene, polyvinylidene difluoride, copolymers of polyvinylidene difluoride and pentafluoropropylene, and the like), hydrocarbon-based polymers (styrene butadiene rubber, butadiene rubber, isoprene rubber, hydrogenated butadiene rubber, hydrogenated styrene butadiene rubber, and the like), acrylic polymers (polymethyl methacrylate, copolymers of polymethyl methacrylate and polymethacrylic acid, and the like), urethane-based polymers (polycondensates of diphenylmethane diisocyanate and polyethylene glycol, and the like), and polyimide-based polymers (polycondensates of a 4,4′-biphthalic anhydride and 3-aminobenzylamine and the like) can be used.

The content of the binder is preferably 0.01% by mass or more, more preferably 0.1% by mass or more, and still more preferably 0.5% by mass or more of the total solid content of the solid electrolyte composition. The upper limit is preferably 20% by mass or less, more preferably 15% by mass or less, and still more preferably 10% by mass or less.

[Dispersion Medium (D)]

The solid electrolyte composition may include a dispersion medium that disperses a variety of components described above. Examples of the dispersion medium include hydrocarbons such as pentane, hexane, heptane, octane, decane, petroleum ether, petroleum benzine, ligroin, petroleum spirit, cyclohexane, methylcyclohexane, toluene, and xylene, and hydrocarbon-based solvents such as dimethylpolysiloxane. In addition, examples thereof include alcohol compound solvents, ether compound solvents, amide compound solvents, ketone compound solvents, aromatic compound solvents, aliphatic compound solvents, nitrile compound solvents, and the like.

Examples of alcohol compound solvents include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of ether compound solvents include alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, dipropylene glycol monomethyl ether, tripropylene glycol monomethyl ether, diethylene glycol monobutyl ether, and the like), dimethyl ether, diethyl ether, tetrahydrofuran, cyclopentyl methyl ether, dimethoxyethane, and 1,4-dioxane.

Examples of amide compound solvents include N,N-dimethylformamide, N-methyl-2-pyrrolidone, N-ethyl-2-pyrrolidone, 2-pyrrolidinone, 1,3-dimethyl-2-imidazolidinone, ε-caprolactam, formamide, N-methylformamide, acetamide, N-methyl acetamide, N,N-dimethylacetamide, N-methylpropionamide, and hexamethylphosphoric triamide.

Examples of ketone compound solvents include acetone, methyl ethyl ketone, methyl isobutyl ketone, diethyl ketone, dipropyl ketone, diisopropyl ketone, diisobutyl ketone, and cyclohexanone.

Examples of aromatic compound solvents include benzene, toluene, xylene, chlorobenzene, and dichlorobenzene.

Examples of aliphatic compound solvents include hexane, heptane, octane, decane, and dodecane.

Examples of nitrile compound solvents include acetonitrile, propionitrile, butyronitrile, isobutyronitrile, and benzonitrile.

Among these dispersion media, the ether compound solvents, the ketone compound solvents, the aromatic compound solvents, and the aliphatic compound solvents are preferred, and the aromatic compound solvents and the aliphatic compound solvents are more preferred.

The boiling point of the dispersion medium at normal pressure (one atmosphere) is preferably 50° C. or higher and more preferably 80° C. or higher. The upper limit is preferably 250° C. or lower and more preferably 220° C. or lower. The dispersion media may be used singly or two or more dispersion media may be used in combination.

The content of the dispersion medium in the solid electrolyte composition can be appropriately adjusted in consideration of the balance between the viscosity and the drying load of the solid electrolyte composition. From the above-described viewpoint, the content of the dispersion medium in the solid electrolyte composition is preferably 20% by mass to 99% by mass of the full mass of the composition.

[Electrode Active Material]

(Positive Electrode Active Material)

To the solid electrolyte composition, a positive electrode active material may be added. When the solid electrolyte composition includes the positive electrode active material, it is possible to produce compositions for positive electrode materials.

As the positive electrode active material, transition metal oxides are preferably used, and, among these, the positive electrode active material preferably has transition elements M^{a} (one or more elements selected from Co, Ni, Fe, Mn, Cu, and V). In addition, mixing elements M^{b} (metal elements belonging to Group I (Ia) of the periodic table other than lithium, elements belonging to Group II (IIa), Al, Ga, In, Ge, Sn, Pb, Sb, Bi, Si, P, B, and the like) may be mixed into the positive electrode active material.

Examples of the transition metal oxides include specific transition metal oxides represented by any one of Formulae (MA) to (MC), and examples of other transition metal oxides include V₂O₅, MnO₂, and the like.

As the positive electrode active material, a particulate positive electrode active material may be used. Specifically, transition metal oxides capable of reversibly intercalating and deintercalating lithium ions can be used, and the specific transition metal oxides described above are preferably used.

Preferred examples of the transition metal oxides include oxides including the transition element M^{a} and the like. In this case, the mixing elements M^{b} (preferably Al) may be mixed into the transition metal oxides. The amount of the mixing element M^{b} mixed is preferably 0% by mol to 30% by mol with respect to the amount of the transition metal.

As oxides including the transition element M^{a}, oxides synthesized by mixing M^{a} so that the molar ratio of Li to M^{a} (Li/M^{a}) reaches 0.3 to 2.2 are more preferred.

[Transition Metal Oxide Represented by Formula (MA) (Bedded Salt-Type Structure)]

As lithium-containing transition metal oxides, among them, transition metal oxides represented by Formula (MA) are preferred.

LiₐM¹O_{b} Formula (MA)

In Formula (MA), M¹ is the same as M^{a} and the preferred range thereof is also identical. a represents 0 to 1.2 and is preferably 0.2 to 1.2 and more preferably 0.6 to 1.1. b represents 1 to 3 and is preferably 2. A part of M¹ may be substituted with the mixing element M^{b}.

The transition metal oxides represented by Formula (MA) typically have a bedded salt-type structure.

The transition metal oxides represented by Formula (MA) are more preferably transition metal oxides represented by individual formulae described below.

Li_{g}CoOₖ (MA-1)

Li_{g}NiOₖ (MA-2)

Li_{g}MnOₖ (MA-3)

Li_{g}CoⱼNi₁₋ⱼOₖ (MA-4)

Li_{g}NiⱼMn₁₋ⱼOₖ (MA-5)

Li_{g}CoⱼNiᵢAl₁₋ⱼ₋ᵢOₖ (MA-6)

Li_{g}CoⱼNiᵢMn₁₋ⱼ₋ᵢOₖ (MA-7)

g is the same as a in Formula (MA) and the preferred range thereof is also identical. j represents 0.1 to 0.9. i represents 0 to 1. However, 1-j-i reaches 0 or more. k is the same as b in Formula (MA) and the preferred range thereof is also identical.

Specific examples of the transition metal oxides include LiCoO₂ (lithium cobalt oxide [LCO]), LiNi₂O₂ (lithium nickelate), LiNi_{0.85}CO_{0.01}Al_{0.05}O₂ (lithium nickel cobalt aluminum oxide [NCA]), LiNi_{0.33}Co_{0.33}Mn_{0.33}O₂ (lithium nickel manganese cobalt oxide [NMC]), and LiNi_{0.5}Mn_{0.5}O₂ (lithium manganese nickelate).

Preferred examples of the transition metal oxides represented by Formula (MA) also include compounds represented by formulae below.

Li_{g}Ni_{xc}Mn_{yc}Co_{zc}O₂ (xc>0.2,yc>0.2,zc≧0,xc+yc+zc=1) (i)

Typical examples will be described below.

Li_{g}Ni_{1/3}Mn_{1/3}Co_{1/3}O₂

Li_{g}Ni_{1/2}Mn_{1/2}O₂

Li_{g}Ni_{xd}Co_{yd}Al_{zd}O₂ (xd>0.7,yd>0.1,0.1>zd≧0.05,xd+yd+zd=1) (ii)

Typical examples will be described below.

Li_{g}Ni_{0.8}Co_{0.15}Al_{0.05}O₂

—Transition Metal Oxide Represented by Formula (MB) (Spinel-Type Structure) —

As lithium-containing transition metal oxides, among them, transition metal oxides represented by Formula (MB) are also preferred.

Li_{c}M²₂O_{d} Formula (MB)

In Formula (MB), M² is the same as M^{a} and the preferred range thereof is also identical. c represents 0 to 2 and is preferably 0.2 to 2 and more preferably 0.6 to 1.5. d represents 3 to 5 and is preferably 4.

The transition metal oxides represented by Formula (MB) are more preferably transition metal oxides represented by individual formulae described below.

In Formula (MB), m is the same as c and the preferred range is also identical. n is the same as d and the preferred range thereof is also identical. p represents 0 to 2.

LiₘMn₂Oₙ (MB-1)

LiₘMnₚAl₂₋ₚOₙ (MB-2)

LiₘMnₚNi₂₋ₚOₙ (MB-3)

Examples of the transition metal oxides include LiMn₂O₄ and LiMn_{1.5}Ni_{0.5}O₄.

Preferred examples of the transition metal oxides represented by Formula (MB) further include compounds represented by individual formulae below. Among these, (e) including Ni is more preferred from the viewpoint of a high capacity and a high output.

(a) LiCoMnO₄

(b) Li₂FeMn₃O₈

(c) Li₂CuMn₃O₈

(d) Li₂CrMn₃O₈

(e) Li₂NiMn₃O₈

—Transition Metal Oxide Represented by Formula (MC) —

As lithium-containing transition metal oxides, lithium-containing transition metal phosphorus oxides are preferred, and compounds represented by Formula (MC) are also preferred.

LiₑM³(PO₄)_{f} Formula (MC)

In Formula (MC), e represents 0 to 2 and is preferably 0.2 to 2 and more preferably 0.5 to 1.5. f represents 1 to 5 and is preferably 1 or 2.

M³ represents one or more elements selected from the group consisting of V, Ti, Cr, Mn, Fe, Co, Ni, and Cu. M³ may be substituted with not only the mixing element M^{b} but also other metal such as Ti, Cr, Zn, Zr, or Nb.

Specific examples include olivine-type iron phosphate salts such as LiFePO₄ and Li₃Fe₂(PO₄)₃, iron pyrophosphates such as LiFeP₂O₇, cobalt phosphates such as LiCoPO₄, monoclinic nasicon-type vanadium phosphate salt such as Li₃V₂(PO₄)₃ (lithium vanadium phosphate).

Meanwhile, the a, c, g, m, and e values representing the compositional ratios of Li in Formulae (MA) to (MC) are values that change due to charging and discharging and are, typically, evaluated as values in a stable state when Li is contained. In a to e, the composition of Li is expressed as specific values, but these values also, similarly, change due to the operation of batteries.

In all solid state secondary batteries not including water, the volume-average particle diameter of the positive electrode active material is not particularly limited, but is preferably 0.1 μm to 50 μm. In order to adjust the positive electrode active material to a predetermined particle diameter, an ordinary crusher or classifier may be used. Positive electrode active materials obtained using a firing method may be used after being washed with water, an acidic aqueous solution, an alkaline aqueous solution, or an organic solvent. The volume-average particle diameter of the positive electrode active material particles is measured using the same method for measuring the volume-average particle diameter of the above-described inorganic solid electrolyte.

The concentration of the positive electrode active material is not particularly limited, but preferably 20% by mass to 90% by mass and more preferably 40% by mass to 80% by mass of the total solid content of the solid electrolyte composition.

Meanwhile, in a case in which the positive electrode layer includes other inorganic solids (for example, solid electrolytes), the total mass of the positive electrode active material and other inorganic solids is preferably the above-described concentration.

(Negative Electrode Active Material)

The solid electrolyte composition may include a negative electrode active material. When including the negative electrode active material, the solid electrolyte composition can be used as compositions for negative electrode materials.

As the negative electrode active material, materials capable of reversibly intercalating and deintercalating lithium ions are preferred. Materials that can be used as the negative electrode active material are not particularly limited, and examples thereof include carbonaceous materials, metal oxides such as tin oxide and silicon oxide, metal complex oxides, lithium single bodies and lithium alloys such as lithium aluminum alloys, and metals capable of forming alloys with lithium such as Sn and Si. These materials may be used singly or two or more materials may be jointly used in an arbitrary combination and fractions. Among these, as the materials that can be used as the negative electrode active material, carbonaceous materials or lithium complex oxides are preferred in terms of safety. In addition, the metal complex oxides are preferably compounds capable of absorbing and emitting lithium and are not particularly limited, but are preferably compounds containing titanium and/or lithium as constituent components from the viewpoint of high-current density charging and discharging characteristics.

Examples of the carbonaceous materials that can be used as the negative electrode active material include carbonaceous materials obtained by firing petroleum pitch, natural graphite, artificial graphite such as highly oriented pyrolytic graphite, and a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

These carbonaceous materials can also be classified into non-graphitizable carbon materials and graphite-based carbon materials depending on the degree of graphitization. In addition, the carbonaceous materials preferably have the surface separation, the density, and the sizes of crystallites described in JP1987-22066A (JP-S62-22066A), JP1990-6856A (JP-H02-6856A), and JP1991-45473A (JP-H03-45473A). The carbonaceous materials do not need to be a sole material, and it is also possible to use the mixtures of a natural graphite and a synthetic graphite described in JP1993-90844A (JP-H05-90844A), the graphite having a coated layer described in JP1994-4516A (JP-H06-4516A), and the like.

The metal oxides and the metal complex oxides that can be used as the negative electrode active material are particularly preferably amorphous oxides, and furthermore, chalcogenides which are reaction products between a metal element and an element belonging to Group XVI of the periodic table are also preferred.

The “amorphous oxides” mentioned herein refer to oxides having a broad scattering band having a peak of a 2θ value in a range of 20° to 40° in an X-ray diffraction intensity curve measured using an X-ray diffraction method in which CuKα rays are used and may have crystalline diffraction lines. The highest intensity in the crystalline diffraction line appearing at the 2θ value of 40° or more and 70° or less is preferably 100 times or less and more preferably five times or less of the diffraction line intensity at the peak of the broad scattering line appearing at the 2θ value of 20° or more and 40° or less and still more preferably does not have any crystalline diffraction lines.

In a compound group including amorphous oxides and chalcogenides, amorphous oxides of semimetal elements and chalcogenides are more preferred, and oxides made of one element or a combination of two or more elements selected from elements belonging to Groups XIII (IIIB) to XV (VB) of the periodic table (Al, Ga, Si, Sn, Ge, Pb, Sb, and Bi) and chalcogenides are still more preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, SnSiS₃, and the like. In addition, these amorphous oxides may be complex oxides with lithium oxide (Li₂SnO₂).

The volume-average particle diameter of the negative electrode active material is preferably 0.1 μm to 60 μm. In order to adjust a predetermined particle diameter, a well-known crusher or classifier (for example, a mortar, a ball mill, a sand mill, an oscillatory ball mill, a satellite ball mill, a planetary ball mill, a swirling airflow-type jet mill, or a sieve) is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind powder classifier, and the like depending on the necessity. Both of dry-type classification and wet-type classification can be carried out. The volume-average particle diameter of the negative electrode active material particles is measured using the same method for measuring the volume-average particle diameter of the inorganic solid electrolyte.

The compositional formula of the compound obtained using the firing method can be obtained using inductively coupled plasma (ICP) or emission spectrometry. In addition, the compositional formula may be obtained from the mass difference of powder before and after firing as a convenient method.

Preferred examples of negative electrode active materials that can be used with the amorphous oxide negative electrode active material containing Sn, Si, or Ge as the central element include carbon materials capable of absorbing and emitting lithium ions or lithium metals, lithium, lithium alloys, and metals capable of forming alloys with lithium.

The negative electrode active material preferably contains a titanium atom. As the negative electrode active material including a titanium element, for example, Li₄Ti₅O₁₂ is preferred since the volume fluctuates only to a small extent during the absorption and emission of lithium ions, and thus high-speed charge and discharge characteristics are excellent, the deterioration of electrodes is suppressed, and it becomes possible to improve the service lives of lithium ion secondary batteries. In addition, it is also preferable to use Si-based negative electrode active materials. Generally, Si-based negative electrode active materials are capable of absorbing a larger number of Li ions than carbonaceous materials (graphite, acetylene black, and the like). Therefore, the amount of Li ions absorbed per unit mass increases, and it is possible to increase battery capacities. As a result, there is an advantage of becoming capable of elongating the battery-operating time.

The concentration of the negative electrode active material is not particularly limited, but is preferably 10% by mass to 80% by mass and more preferably 20% by mass to 70% by mass of total solid content of the solid electrolyte composition. The total mass of the negative electrode active material and other inorganic solids (for example, inorganic solid electrolytes) is preferably the above-described concentration.

Meanwhile, in the above-described embodiment, an example in which the positive electrode active material and the negative electrode active material are added to the solid electrolyte composition of the embodiment of the present invention has been described, but the embodiment of the present invention is not interpreted to be limited thereto.

For example, paste including a positive electrode active material and a negative electrode active material may be prepared using polymers.

In addition, to the active material layers in the positive electrode and the negative electrode, a conduction aid may be appropriately added as necessary. As an ordinary conduction aid, it is possible to add graphite, carbon black, acetylene black, Ketjenblack, a carbon fiber, metal powder, a metal fiber, a polyphenylene derivative, or the like as an electron-conducting material.

<Electrode Sheet for Battery>

The electrode sheet for a battery has a collector and an inorganic solid electrolyte-containing layer disposed on the collector using the solid electrolyte composition of the embodiment of the present invention. In the electrode sheet for a battery, since the inorganic solid electrolyte-containing layer is formed using the solid electrolyte composition of the embodiment of the present invention, the resistance of the inorganic solid electrolyte-containing layer is small, the bonding properties between the inorganic solid electrolyte-containing layer and the collector are favorable, and interface resistance can be maintained at a low level. Therefore, in the case of producing secondary batteries, it is possible to favorably maintain the cycle characteristics for a long period of time.

Meanwhile, the inorganic solid electrolyte-containing layer refers to a layer containing the inorganic solid electrolyte (A) and the compound (B) represented by General Formula (1). To the inorganic solid electrolyte-containing layer, a positive electrode active material layer, a negative electrode active material layer, and an inorganic solid electrolyte layer are provided.

The structure of the electrode sheet for a battery may be, for example, a laminated structure of a positive electrode-side collector (for example, a metal foil)/an inorganic solid electrolyte layer/a negative electrode-side collector (for example, a metal foil) or a laminated structure of a positive electrode-side collector (for example, a metal foil)/a positive electrode active material layer/an inorganic solid electrolyte layer/a negative electrode active material layer/a negative electrode-side collector (for example, a metal foil).

For example, in the latter structure, since a positive electrode active material layer, an inorganic solid electrolyte layer, and a negative electrode active material layer are formed using the solid electrolyte composition of the embodiment of the present invention, the resistances of the respective layers are suppressed at a low level, furthermore, bonding properties in individual interfaces between the positive electrode active material layer and the collector and between the negative electrode active material layer and the collector, in the interface between the positive electrode active material layer and the inorganic solid electrolyte layer, and the interface between the inorganic solid electrolyte layer and the negative electrode active material layer are favorable, and interface resistance can be maintained at a low level. Therefore, excellent cycle characteristics are developed for a long period of time.

Meanwhile, the details of the inorganic solid electrolyte layer and the solid electrolyte composition are as described above, and the positive electrode active material layer and the negative electrode active material layer can be preferably formed using the solid electrolyte composition described above.

The solid electrolyte composition is preferably used as a material for forming the negative electrode active material layer, the positive electrode active material layer, and the inorganic solid electrolyte layer.

[Collectors]

Collectors function as electrodes in a case in which all solid state secondary batteries are produced and are generally disposed as the positive electrode and the negative electrode. As the collectors as the positive electrode and the negative electrode, electron conductors that do not chemically change are preferably used.

The collector of the positive electrode is preferably aluminum, stainless steel, nickel, titanium, or the like, additionally, preferably a collector obtained by treating the surface of aluminum or stainless steel with carbon, nickel, titanium, or silver, and, among these, aluminum and aluminum alloys are more preferred.

The collector of the negative electrode is preferably aluminum, copper, stainless steel, nickel, or titanium and more preferably aluminum, copper, or a copper alloy.

Regarding the shape of the collector, generally, collectors having a film-like shape or a sheet-like shape or foils are preferred. In addition, the shape of the collector may be a net-like shape, a punched shape, a lath body, a porous body, a foam, a compact of fiber groups, or the like.

The thickness of the collector is not particularly limited, but is preferably 1 μm to 500 μm. In addition, the surface of the collector is preferably provided with protrusions and recesses by means of a surface treatment.

˜Method for Manufacturing Electrode Sheet for Battery˜

The electrode sheet for a battery may be produced using a well-known method and is preferably produced using a method having a step of applying the solid electrolyte composition of the embodiment of the present invention onto the collector so as to form the inorganic solid electrolyte-containing layer.

Specifically, the solid electrolyte composition is applied onto, for example, a metal foil which serves as the collector using a well-known method such as a coating method, and a film of the solid electrolyte composition is formed, thereby producing an electrode sheet for a battery.

For example, the electrode sheet for a battery can be more preferably produced using a method described below.

First, a metal foil which is a positive electrode collector is prepared, a composition which serves as a positive electrode material is applied onto the metal foil and then dried, thereby producing a positive electrode sheet having a positive electrode active material layer. Next, the solid electrolyte composition is applied onto the positive electrode active material layer of the positive electrode sheet and furthermore dried, thereby forming an inorganic solid electrolyte layer. Furthermore, a composition which serves as a negative electrode material is applied onto the formed inorganic solid electrolyte layer and dried, thereby forming a negative electrode active material layer. After that, a negative electrode-side collector (metal foil) is overlaid on the negative electrode active material layer. An all solid state secondary battery having the inorganic solid electrolyte layer sandwiched between the positive electrode active material layer and the negative electrode active material layer can be produced in the above-described manner.

Meanwhile, the respective compositions described above may be applied using an ordinary method.

A composition for forming the positive electrode active material layer, a composition for forming the inorganic solid electrolyte layer (solid electrolyte composition), and a composition for forming the negative electrode active material layer may be dried separately every time each of the compositions is applied or the respective compositions may be applied into multiple layers and then collectively dried.

The drying temperature is not particularly limited, but is preferably 30° C. or higher and more preferably 60° C. or higher. The drying temperature is preferably 300° C. or lower and more preferably 250° C. or lower. When the compositions are heated and dried in the above-described temperature range, dispersion media are removed in a case in which the dispersion media are included, and solid-form laminate structures can be obtained.

In a case in which an all solid state secondary battery is produced in the above-described manner, it is possible to improve the bonding properties in individual interfaces in the laminate structure of the positive electrode active material layer/the inorganic solid electrolyte layer/the negative electrode active material layer and ensure excellent ion conductivity even in the absence of pressure.

<All Solid State Secondary Battery>

The all solid state secondary battery has a collector, a positive electrode active material layer, a negative electrode active material layer, and an inorganic solid electrolyte layer disposed between the positive electrode active material layer and the negative electrode active material layer, and at least one layer of the positive electrode active material layer, the negative electrode active material layer, or the inorganic solid electrolyte layer includes the inorganic solid electrolyte (A) having a conductivity of ions of metals belonging to Group I or II of the periodic table and the compound (B) represented by General Formula (1).

In addition, the all solid state secondary battery includes at least the electrode sheet for a battery of the embodiment of the present invention.

When including the electrode sheet for a battery of the embodiment of the present invention, the all solid state secondary battery has excellent cycle characteristics.

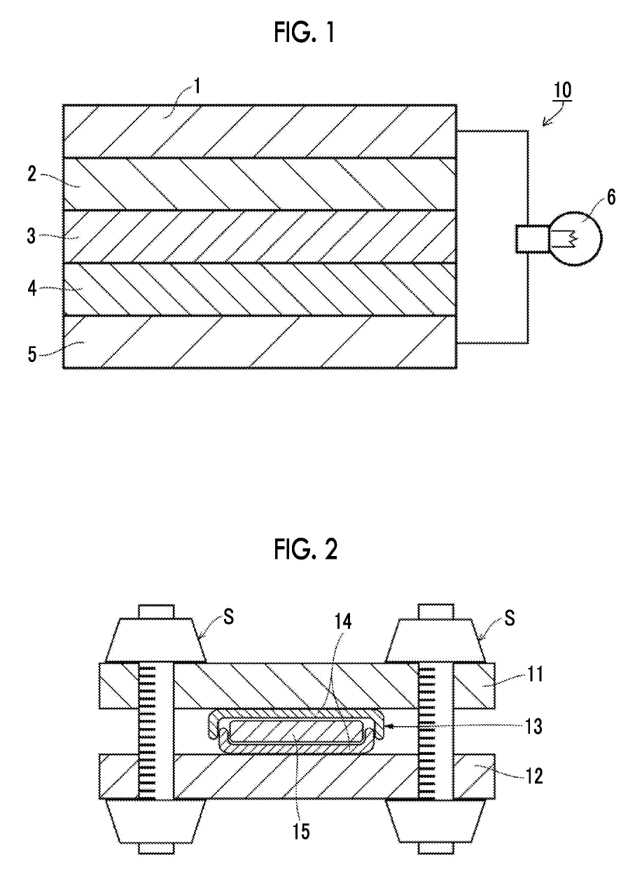

Hereinafter, the all solid state secondary battery according to the embodiment will be described with reference to FIG. 1. FIG. 1 is a cross-sectional view schematically illustrating the all solid state secondary battery (lithium ion secondary battery) according to a preferred embodiment.

An all solid state secondary battery 10 has a structure in which a negative electrode collector 1, a negative electrode active material layer 2, an inorganic solid electrolyte layer 3, a positive electrode active material layer 4, and a positive electrode collector 5 are provided in this order when seen from the negative electrode side. The respective layers are in contact with each other and laminated together, and at least one layer includes the inorganic solid electrolyte (A) and the compound (B) represented by General Formula (1), and thus the deterioration due to moisture and oxidation and reduction deterioration of the inorganic solid electrolyte are suppressed. Therefore, high voltages can be obtained, and the cycle characteristics of secondary batteries can be favorably maintained even after long-term use.

When the all solid state secondary battery has the above-described laminate structure, in the case of charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode side, and electrons are supplied to an operation portion 6.

In the all solid state secondary battery 10 illustrated in FIG. 1, an electric bulb is employed as the operation portion 6 and is lighted by discharging.

The thicknesses of the positive electrode active material layer 4, the inorganic solid electrolyte layer 3, and the negative electrode active material layer 2 are not particularly limited, but are preferably 10 μm to 1,000 μm and more preferably 100 μm to 500 μm in a case in which ordinary dimensions of batteries are taken into account.

<Production of all Solid State Secondary Battery>

The all solid state secondary battery may be produced using an ordinary method and preferably produced using a method having a step of applying the solid electrolyte composition of the embodiment of the present invention onto the collector so as to form the solid electrolyte film layer.

Specifically, an electrode sheet for a battery is produced by providing a step for forming a solid electrolyte layer in the same manner as for the production of the electrode sheet for a battery, then, a disc-shaped piece having a desired size (for example, a diameter of 14.5 mm) is cut out as illustrated in FIG. 2 from the electrode sheet for a battery so as to produce a disc-shaped electrode sheet 15, the disc-shaped electrode sheet 15 is put into, for example, a 2032-type stainless steel coin case 14 and tightened with a necessary pressure, whereby a coin-type all solid state secondary battery 13 can be produced. The necessary pressure may be applied by, for example, as illustrated in FIG. 2, sandwiching the coin case 14 into which the disc-shaped electrode sheet 15 is put between an upper portion-supporting plate 11 and a lower portion-supporting plate 12 and tightening the components using a pressurizing screw S.

In addition, the all solid state secondary battery can also be produced using the electrode sheet for a battery.

˜Applications of all Solid State Secondary Battery˜

The all solid state secondary battery can be applied to a variety of applications. Application aspects are not particularly limited. In the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, memory cards, portable tape recorders, radios, backup power supplies, and the like. Additionally, examples of consumer applications include automobiles, electric vehicles, motors, lighting equipment, toys, game devices, road conditioners, watches, strobes, cameras, medical devices (pacemakers, hearing aids, shoulder massage devices, and the like), and the like.

Furthermore, the all solid state secondary battery can be used for a variety of military applications and universe applications. In addition, the all solid state secondary battery can also be combined with solar batteries.

Among these applications, the all solid state secondary battery is preferably applied to applications for which a high capacity and high rate discharging characteristics are required. For example, in electricity storage facilities expected to have a high capacity, high reliability becomes essential, and furthermore, the satisfaction of battery performance is required. In addition, high-capacity secondary batteries are mounted in electric vehicles and the like and are assumed to be used in domestic applications in which charging is carried out every day, and thus better reliability for overcharging is required.

According to the embodiment of the present invention, it is possible to suppress an increase in interface resistance among solid particles, between solid particles and the collector, and the like and realized a high ion conductivity, favorable cycle characteristics obtained by suppressing the oxidation and reduction deterioration of the inorganic solid electrolyte, and moisture resistance.

### EXAMPLES

Hereinafter, an embodiment of the present invention will be more specifically described using examples. The scope of the embodiment of the present invention is not limited to specific examples described below. Furthermore, unless particularly otherwise described, “parts” is mass-based.

<Manufacturing of Solid Electrolyte Composition>

[Syntheses of Polymer Dispersants (Exemplary Compounds and Comparative Compounds)]

Exemplary Compounds B-1, B-2, B-4, B-5, B-7, B-9, B-17 to B-21 (the compound represented by General Formula (1)), and Comparative Compound 1 were synthesized as described below.

(Exemplary Compound B-1)

Dipentaerythritol hexakis(3-mercaptopropionate) [DPMP; manufactured by Sakai Chemical Industry Co., Ltd.] (7.83 parts) and glycerin monoacrylate (7.31 parts) were dissolved in 1-methoxy-2-propanol (35.32 parts) and heated to 70° C. under a nitrogen stream. 2,2′-Azobis(2,4-dimethylvaleronitrile) [V-65, manufactured by Wako Pure Chemical Industries, Ltd.] (0.06 parts) was added thereto and heated for three hours. Furthermore, V-65 (0.06 parts) was added thereto and reacted at 70° C. under a nitrogen stream for three hours. After a reaction, the solution was cooled to room temperature, thereby synthesizing a solution of 30% by mass of a mercaptan compound.

Methyl methacrylate (90 parts) and 1-methoxy-2-propanol (210 parts) were added to the synthesized solution of 30% by mass of a mercaptan compound, 2,2′-azobis(isobutyronitrile) [AIBN, manufactured by Wako Pure Chemical Industries, Ltd.] (0.49 parts) was added thereto under a nitrogen stream and heated for three hours, then, AIBN (0.49 parts) was further add thereto, and a reaction was caused at 80° C. under a nitrogen stream for three hours. After that, the solution was cooled to room temperature and diluted with acetone. Precipitation was caused again using a large amount of methanol, and then the solution was dried in a vacuum, thereby obtaining Exemplary Compound B-1. Meanwhile, the weight-average molecular weight of Exemplary Compound B-1 was 10,000, and the formula weight of the group represented by P¹ in General Formula (1) was 2,200.

(Exemplary Compound B-2)

Exemplary Compound B-2 was synthesized according to the same order as Exemplary Compound B-1 except for the fact that, in the synthesis of Exemplary Compound B-1, glycerin monoacrylate (7.31 parts) was changed to itaconic acid (6.51 parts) and methyl methacrylate (90 parts) was changed to dodecyl methacrylate (230 parts). Meanwhile, the weight-average molecular weight of Exemplary Compound B-2 was 21,000, and the formula weight of the group represented by P¹ in General Formula (1) was 4,200.

(Exemplary Compound B-4)

Exemplary Compound B-4 was synthesized according to the same order as Exemplary Compound B-2 except for the fact that, in the synthesis of Exemplary Compound B-2, dodecyl methacrylate (230 parts) was changed to stearyl methacrylate (230 parts). Meanwhile, the weight-average molecular weight of Exemplary Compound B-4 was 53,000, and the formula weight of the group represented by P¹ in General Formula (1) was 8,750.

(Exemplary Compound B-5)

Exemplary Compound B-5 was synthesized according to the same order as Exemplary Compound B-4 except for the fact that, in the synthesis of Exemplary Compound B-4, dodecyl methacrylate (230 parts) was changed to dodecyl methacrylate (150 parts) and styrene (30 parts). Meanwhile, the weight-average molecular weight of Exemplary Compound B-5 was 21,300, and the formula weight of the group represented by P¹ in General Formula (1) was 7,800.

(Exemplary Compound B-7)

Exemplary Compound B-7 was synthesized according to the same order as Exemplary Compound B-1 except for the fact that, in the synthesis of Exemplary Compound B-1, methyl methacrylate was changed to propyl methacrylate. Meanwhile, the weight-average molecular weight of Exemplary Compound B-7 was 13,200, and the formula weight of the group represented by P¹ in General Formula (1) was 3,500.

(Exemplary Compound B-9)

Exemplary Compound B-9 was synthesized according to the same order as Exemplary Compound B-1 except for the fact that, in the synthesis of Exemplary Compound B-1, methyl methacrylate was changed to a monomer having a structure illustrated below. Meanwhile, the weight-average molecular weight of Exemplary Compound B-9 was 221,000, and the formula weight of the group represented by P¹ in General Formula (1) was 52,000.

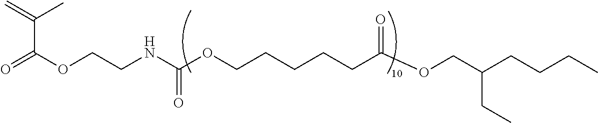

(Exemplary Compound B-17)

Dipentaerythritol (manufactured by Tokyo Chemical Industry Co., Ltd.) (11.4 g) was added to a three-neck flask, heated and dissolved at 220° C. under a nitrogen stream. Stearic acid (manufactured by Tokyo Chemical Industry Co., Ltd.) (50 g) was added thereto and heated and stirred at 230° C. for five hours. During the heating and stirring, water produced as a by-product was removed using a Dean-Stark. Next, the obtained viscous oil was cooled to 170° C., a succinic anhydride (manufactured by Wako Pure Chemical Industries, Ltd.) (9 g) was added thereto and, furthermore, continuously heated and stirred at 170° C. for four hours. The obtained viscous oil was placed in a TEFLON (registered trademark) tray and cooled to room temperature, thereby obtaining Exemplary Compound B-17 as a light yellow solid. Meanwhile, the weight-average molecular weight of Exemplary Compound B-17 was 1,200, and the formula weight of the group represented by P¹ in General Formula (1) was 239.

(Exemplary Compound B-18)

Dipentaerythritol (manufactured by Tokyo Chemical Industry Co., Ltd.) (9.3 g) was added to a three-neck flask, heated and dissolved at 220° C. under a nitrogen stream. Stearic acid (manufactured by Tokyo Chemical Industry Co., Ltd.) (50 g) was added thereto and heated and stirred at 230° C. for five hours. During the heating and stirring, water produced as a by-product was removed using a Dean-Stark. The obtained viscous oil was placed in a TEFLON (registered trademark) tray and cooled to room temperature, thereby obtaining Exemplary Compound B-18 as a light yellow solid. Meanwhile, the weight-average molecular weight of Exemplary Compound B-18 was 850, and the formula weight of the group represented by P¹ in General Formula (1) was 239.

(Exemplary Compound B-19)

Exemplary Compound B-19 was synthesized using the same method as Exemplary Compound B-17 except for the fact that, in the synthesis of Exemplary Compound B-17, stearic acid was changed to oleic acid. Meanwhile, the weight-average molecular weight of Exemplary Compound B-19 was 1,000, and the formula weight of the group represented by P¹ in General Formula (1) was 237.

(Exemplary Compound B-20)

Exemplary Compound B-20 was synthesized using the same method as Exemplary Compound B-17 except for the fact that, in the synthesis of Exemplary Compound B-17, stearic acid was changed to linolenic acid. Meanwhile, the weight-average molecular weight of Exemplary Compound B-20 was 950, and the formula weight of the group represented by P¹ in General Formula (1) was 235.

(Exemplary Compound B-21)

Exemplary Compound B-21 was synthesized using the same method as Exemplary Compound B-17 except for the fact that, in the synthesis of Exemplary Compound B-17, the succinic anhydride (9 g) was changed to a phthalic anhydride (13.1 g). Meanwhile, the weight-average molecular weight of Exemplary Compound B-21 was 890, and the formula weight of the group represented by P¹ in General Formula (1) was 235.

(Comparative Compound 1) 2-Hydroxyethyl methacrylate (45 parts), methyl methacrylate (45 parts), and 1-methoxy-2-propanol (210 parts) were mixed together, 2,2′-azobis(isobutyronitrile) [AIBN, manufactured by Wako Pure Chemical Industries, Ltd.] (0.49 parts) was added thereto under a nitrogen stream, heated at 80° C. for three hours, then, AIBN (0.49 parts) was further add thereto, and a reaction was caused at 80° C. for three hours under a nitrogen stream. After a reaction, the solution was cooled to room temperature, precipitation was caused again using a large amount of methanol, and the solution was dried in a vacuum, thereby obtaining Comparative Compound 1 (having the following structure).

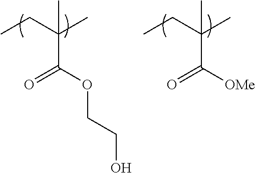

[Synthesis of Sulfide-Based Inorganic Solid Electrolyte (Li/P/S-Based Glass)]

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp 231 to 235 and A. Hayashi, S. Hama, H. Morimoto, M. Tatsumisago, T. Minami, Chem. Lett., (2001), pp 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed and injected into an agate mortar and were mixed together for five minutes using an agate muddler. Meanwhile, the molar ratio between Li₂S and P₂S₅ was set to Li₂S:P₂S₅=75:25.

Sixty six zirconia beads having a diameter of 5 mm were injected into a 45 mL zirconia container (manufactured by Fritsch Japan Co., Ltd.), the full amount of a mixture of the lithium sulfide and the diphosphorus pentasulfide was injected thereinto, and the container was completely sealed in an argon atmosphere. This container was set in a planetary ball mill P-7 (manufactured by Fritsch Japan Co., Ltd.), mechanical milling was carried out at 25° C. and a rotation speed of 510 rpm for 20 hours, thereby obtaining yellow powder (6.20 g) of a sulfide-based solid electrolyte (Li/P/S-based glass).

˜Preparation of Solid Electrolyte Composition˜

(1) Preparation of Solid Electrolyte Composition (K-1)

180 Zirconia beads having a diameter of 5 mm were injected into a 45 mL zirconia container (manufactured by Fritsch Japan Co., Ltd.), and an oxide-based inorganic solid electrolyte LLZ (manufactured by Toshima Manufacturing Co., Ltd., inorganic solid electrolyte) (9.0 g), Exemplary Compound B-1 (the compound represented by General Formula (1)) (0.3 g), and toluene (15.0 g) as a dispersion medium were injected thereinto. After that, this container was set in a planetary ball mill P-7 (manufactured by Fritsch Japan Co., Ltd.), and the components were continuously stirred at a temperature of 25° C. and a rotation speed of 300 rpm for two hours, thereby obtaining a solid electrolyte composition (K-1).

(2) Preparation of Solid Electrolyte Compositions (K-2) to (K-8) and (HK-1) to (HK-3)

Solid electrolyte compositions (K-2) to (K-8) and (HK-1) to (HK-3) were prepared using the same method as the solid electrolyte composition (K-1) except for the fact that, in the preparation of the solid electrolyte composition (K-1), the exemplary compound, the inorganic solid electrolyte, the binder, and the dispersion medium are changed as shown in Table 1 (refer to Table 1).

Meanwhile, the solid electrolyte compositions (K-1) to (K-8) are the solid electrolyte composition of the present invention, and the solid electrolyte compositions (HK-1) to (HK-3) are comparative solid electrolyte compositions.

TABLE 1

| | | | Inorganic solid | | | | Dispersion | |
|---|---|---|---|---|---|---|---|---|
| Solid | Polymer dispersant | | electrolyte (A) | | Binder (C) | | medium | |
| electrolyte | | Parts by | | Parts by | | Parts by | | Parts by |
| composition | Type | mass | Type | mass | Type | mass | Type | mass |
| K-1 | Exemplary | 0.3 | LLZ | 9.0 | — | — | Toluene | 15.0 |
| | Compound | | | | | | | |
| | B-1 | | | | | | | |
| K-2 | Exemplary | 0.3 | Li/P/S | 9.0 | — | — | Heptane | 15.0 |
| | Compound | | | | | | | |
| | B-1 | | | | | | | |
| K-3 | Exemplary | 0.3 | LLZ | 9.0 | PVdF | 0.5 | Toluene | 15.0 |
| | Compound | | | | | | | |
| | B-2 | | | | | | | |
| K-4 | Exemplary | 0.3 | Li/P/S | 9.0 | PVdF | 0.5 | Heptane | 15.0 |
| | Compound | | | | | | | |
| | B-2 | | | | | | | |
| K-5 | Exemplary | 0.3 | Li/P/S | 9.0 | SBR | 0.1 | Octane | 15.0 |
| | Compound | | | | | | | |
| | B-5 | | | | | | | |
| K-6 | Exemplary | 0.3 | Li/P/S | 9.0 | — | — | Heptane | 15.0 |
| | Compound | | | | | | | |
| | B-17 | | | | | | | |
| K-7 | Exemplary | 0.3 | Li/P/S | 9.0 | SBR | 0.1 | Toluene | 15.0 |
| | Compound | | | | | | | |
| | B-19 | | | | | | | |
| K-8 | Exemplary | 0.3 | Li/P/S | 9.0 | — | — | Heptane | 15.0 |
| | Compound | | | | | | | |
| | B-20 | | | | | | | |
| HK-1 | Comparative | 0.3 | Li/P/S | 9.0 | — | — | Heptane | 15.0 |
| | Compound 1 | | | | | | | |
| HK-2 | Comparative | 0.3 | Li/P/S | 9.0 | — | — | Heptane | 15.0 |
| | Compound 2 | | | | | | | |
| HK-3 | Comparative | 0.3 | Li/P/S | 9.0 | SBR | 0.1 | Heptane | 15.0 |
| | Compound 3 | | | | | | | |

Expressions shown in Table 1 will be described below.

LLZ: Li₇La₃Zr₂O₁₂ (volume-average particle diameter: 5.06 μm, manufactured by Toshima Manufacturing Co., Ltd.)

Li/P/S: Li/P/S-based glass synthesized above

Comparative Compound 1: Acrylic resin described above

Comparative Compound 2: Branched hydrogenated butadiene rubber (manufactured by JSR Corporation, the hydrogen addition percentage: 94%, the number-average molecular weight: 500,000 to 600,000, a structure in which four linear polymers extended from a central carbon atom (the number of carbon atoms in each main chain is at least 10 or more))

Comparative Compound 3: Carboxylic acid-containing hydrogenated styrene butadiene rubber, TUFTEC M1911 (manufactured by Asahi Kasei Corporation)

PVdF: Polyvinylidene difluoride

SBR: Styrene butadiene rubber

<Production of all Solid State Secondary Batteries>

˜Preparation of Compositions for Secondary Battery Positive Electrode˜

(1) Preparation of Composition for Positive Electrode (U-1)

180 Zirconia beads having a diameter of 5 mm were injected into a 45 mL zirconia container (manufactured by Fritsch Japan Co., Ltd.), and an oxide solid electrolyte LLZ (manufactured by Toshima Manufacturing Co., Ltd., inorganic solid electrolyte) (2.7 g), Exemplary Compound B-1 (the compound represented by General Formula (1)) (0.3 g), and toluene (12.3 g) as a dispersion medium were injected thereinto. After that, this container was set in a planetary ball mill P-7 (manufactured by Fritsch Japan Co., Ltd.), the components were continuously stirred at a temperature of 25° C. and a rotation speed of 300 rpm for two hours, and LCO (manufactured by Nippon Chemical Industrial Co., Ltd., LiCoO₂, lithium cobalt oxide) (7.0 g) as an active material was injected into the container, this container was set in a planetary ball mill P-7, and the components were continuously mixed at a temperature of 25° C. and a rotation speed of 100 rpm for 15 minutes, thereby preparing a composition for a positive electrode (U-1).

(2) Preparation of Compositions for Positive Electrode (U-2) to (U-8) and (HU-1) and (HU-2)

Compositions for a positive electrode (U-2) to (U-8) and (HU-1) and (HU-2) were prepared in the same manner as the composition for a positive electrode (U-1) except for the fact that, in the preparation of the composition for a positive electrode (U-1), the polymer dispersant, the inorganic solid electrolyte, the positive electrode active material, the binder, and the dispersion medium were changed as shown in Table 2.

In Table 2, the constitutions of the compositions for a positive electrode are summarized.

The compositions for a positive electrode (U-1) to (U-8) are solid electrolyte compositions which serve as examples, and the compositions for a positive electrode (HU-1) and (HU-2) are compositions for a positive electrode for comparison.

TABLE 2

| | | | Inorganic solid | | Positive electrode | | | | | |
|---|---|---|---|---|---|---|---|---|---|---|
| Composition | Polymer dispersant | | electrolyte (A) | | active material | | Binder (C) | | Dispersion medium | |
| for positive | | Parts by | | Parts by | | Parts by | | Parts by | | Parts by |
| electrode | Type | mass | Type | mass | Type | mass | Type | mass | Type | mass |
| U-1 | Exemplary | 0.3 | LLZ | 2.7 | LCO | 7.0 | — | — | Toluene | 12.3 |
| | Compound | | | | | | | | | |
| | B-1 | | | | | | | | | |
| U-2 | Exemplary | 0.3 | Li/P/S | 2.7 | NMC | 7.0 | — | — | Heptane | 12.3 |
| | Compound | | | | | | | | | |
| | B-1 | | | | | | | | | |
| U-3 | Exemplary | 0.3 | LLZ | 2.7 | LCO | 7.0 | PVdF | 0.6 | Toluene | 12.3 |
| | Compound | | | | | | | | | |
| | B-5 | | | | | | | | | |
| U-4 | Exemplary | 0.3 | Li/P/S | 2.7 | NMC | 7.0 | — | — | Heptane | 12.3 |
| | Compound | | | | | | | | | |
| | B-5 | | | | | | | | | |
| U-5 | Exemplary | 0.3 | Li/P/S | 2.7 | LCO | 7.0 | SBR | 0.2 | Octane | 12.3 |
| | Compound | | | | | | | | | |
| | B-7 | | | | | | | | | |
| U-6 | Exemplary | 0.3 | Li/P/S | 2.7 | NMC | 7.0 | PVdF | 0.6 | Octane | 12.3 |
| | Compound | | | | | | | | | |
| | B-9 | | | | | | | | | |
| U-7 | Exemplary | 0.3 | Li/P/S | 2.7 | NMC | 7.0 | — | — | Heptane | 12.3 |
| | Compound | | | | | | | | | |
| | B-17 | | | | | | | | | |
| U-8 | Exemplary | 0.3 | Li/P/S | 2.7 | NMC | 7.0 | SBR | 0.2 | Heptane | 12.3 |
| | Compound | | | | | | | | | |
| | B-20 | | | | | | | | | |
| HU-1 | Comparative | 0.3 | Li/P/S | 2.7 | NMC | 7.0 | — | — | Heptane | 12.3 |
| | Compound 2 | | | | | | | | | |
| HU-2 | Comparative | 0.3 | Li/P/S | 2.7 | NMC | 7.0 | SBR | 0.2 | Heptane | 12.3 |
| | Compound 3 | | | | | | | | | |

Expressions shown in Table 2 will be described below.

LLZ: Li₇La₃Zr₂O₁₂ (volume-average particle diameter: 5.06 μm, manufactured by Toshima Manufacturing Co., Ltd.)

Li/P/S: Li/P/S-based glass synthesized above

LCO: LiCoO₂ lithium cobalt oxide

NMC: Li(Ni_{1/3}Mn_{1/3}Co_{1/3})O₂ nickel, manganese, lithium cobalt oxide

Comparative Compound 2: Branched hydrogenated butadiene rubber (manufactured by JSR Corporation, the hydrogen addition percentage: 94%, the number-average molecular weight: 500,000 to 600,000, a structure in which four linear polymers extended from a central carbon atom (the number of carbon atoms in each main chain is at least 10 or more))

Comparative Compound 3: Carboxylic acid-containing hydrogenated styrene butadiene rubber, TUFTEC M1911 (manufactured by Asahi Kasei Corporation)

PVdF: Polyvinylidene difluoride

SBR: Styrene butadiene rubber

˜Preparation of Composition for Secondary Battery Negative Electrode˜

(1) Preparation of Composition for Negative Electrode (S-1)

180 Zirconia beads having a diameter of 5 mm were injected into a 45 mL zirconia container (manufactured by Fritsch Japan Co., Ltd.), and an oxide-based inorganic solid electrolyte LLZ (manufactured by Toshima Manufacturing Co., Ltd., inorganic solid electrolyte) (5.0 g), Exemplary Compound B-2 (the compound represented by General Formula (1)) (0.5 g), and toluene (12.3 g) as a dispersion medium were injected thereinto. This container was set in a planetary ball mill P-7 (manufactured by Fritsch Japan Co., Ltd.), the components were continuously dispersed mechanically at a temperature of 25° C. and a rotation speed of 300 rpm for two hours, then, acetylene black (AB) (7.0 g) was injected into the container, this container was set in a planetary ball mill P-7, and the components were continuously mixed at a temperature of 25° C. and a rotation speed of 100 rpm for 15 minutes, thereby preparing a composition for a negative electrode (S-1).

(2) Preparation of Compositions for Negative Electrode (S-2) to (S-8) and (HS-1) and (HS-2)

Compositions for a negative electrode (S-2) to (S-8) and (HS-1) and (HS-2) were prepared in the same manner as the composition for a negative electrode (S-1) except for the fact that, in the preparation of the composition for a negative electrode (S-1), the polymer dispersant, the inorganic solid electrolyte, the negative electrode active material, the binder, and the dispersion medium were changed as shown in Table 3.

In Table 3, the constitutions of the compositions for a negative electrode are summarized.

The compositions for a negative electrode (S-1) to (S-8) are solid electrolyte compositions which serve as examples, and the compositions for a negative electrode (HS-1) and (HS-2) are compositions for a negative electrode for comparison.

TABLE 3

| | | | Inorganic solid | | Negative electrode | | | | Dispersion | |
|---|---|---|---|---|---|---|---|---|---|---|
| Composition | Polymer dispersant | | electrolyte (A) | | active material | | Binder (C) | | medium | |
| for negative | | Parts by | | Parts by | | Parts by | | Parts by | | Parts by |
| electrode | Type | mass | Type | mass | Type | mass | Type | mass | Type | mass |
| S-1 | Exemplary | 0.5 | LLZ | 5.0 | AB | 7.0 | — | — | Toluene | 12.3 |
| | Compound | | | | | | | | | |
| | B-2 | | | | | | | | | |
| S-2 | Exemplary | 0.5 | Li/P/S | 5.0 | AB | 7.0 | — | — | Heptane | 12.3 |
| | Compound | | | | | | | | | |
| | B-2 | | | | | | | | | |
| S-3 | Exemplary | 0.5 | LLZ | 5.0 | AB | 7.0 | PVdF | 0.2 | Toluene | 12.3 |
| | Compound | | | | | | | | | |
| | B-4 | | | | | | | | | |
| S-4 | Exemplary | 0.5 | Li/P/S | 5.0 | AB | 7.0 | PVdF | 0.2 | Heptane | 12.3 |
| | Compound | | | | | | | | | |
| | B-17 | | | | | | | | | |
| S-5 | Exemplary | 0.5 | Li/P/S | 5.0 | AB | 7.0 | — | — | Heptane | 12.3 |
| | Compound | | | | | | | | | |
| | B-18 | | | | | | | | | |
| S-6 | Exemplary | 0.5 | Li/P/S | 5.0 | AB | 7.0 | PVdF | 0.2 | Heptane | 12.3 |
| | Compound | | | | | | | | | |
| | B-19 | | | | | | | | | |
| S-7 | Exemplary | 0.5 | Li/P/S | 5.0 | AB | 7.0 | — | — | Octane | 12.3 |
| | Compound | | | | | | | | | |
| | B-20 | | | | | | | | | |
| S-8 | Exemplary | 0.5 | Li/P/S | 5.0 | AB | 7.0 | PVdF | 0.2 | Octane | 12.3 |
| | Compound | | | | | | | | | |
| | B-21 | | | | | | | | | |
| HS-1 | Comparative | 0.5 | Li/P/S | 5.0 | AB | 7.0 | — | — | Heptane | 12.3 |
| | Compound 2 | | | | | | | | | |
| HS-2 | Comparative | 0.5 | Li/P/S | 5.0 | AB | 7.0 | PVdF | 0.2 | Dioxane | 12.3 |
| | Compound 3 | | | | | | | | | |

Expressions shown in Table 3 will be described below.

LLZ: Li₇La₃Zr₂O₁₂ (volume-average particle diameter: 5.06 μm, manufactured by Toshima Manufacturing Co., Ltd.)

Li/P/S: Li/P/S-based glass synthesized above

AB: Acetylene black

Comparative Compound 2: Branched hydrogenated butadiene rubber (manufactured by JSR Corporation, the hydrogen addition percentage: 94%, the number-average molecular weight: 500,000 to 600,000, a structure in which four linear polymers extended from a central carbon atom (the number of carbon atoms in each main chain is at least 10 or more))

Comparative Compound 3: Carboxylic acid-containing hydrogenated styrene butadiene rubber, TUFTEC M1911 (manufactured by Asahi Kasei Corporation)

PVdF: Polyvinylidene difluoride

˜Production of Positive Electrode Sheets for Secondary Battery˜

Each of the compositions for a secondary battery positive electrode prepared above was applied onto a 20 μm-thick aluminum foil (onto a collector) using an applicator having an adjustable clearance, heated at 80° C. for one hour, and then, furthermore, heated at 110° C. for one hour, and a coating solvent was dried. After that, the composition was heated and pressurized using a heat press machine so as to obtain an arbitrary density, thereby obtaining a 150 μm-thick positive electrode sheet for a secondary battery having a laminate structure of the positive electrode active material layer/the aluminum foil.

˜Production of Electrode Sheet for Secondary Battery˜

Each of the solid electrolyte compositions (K-1) to (K-8) and (HK-1) to (HK-3) prepared above was applied onto the positive electrode sheet for a secondary battery produced above using an applicator having an adjustable clearance, heated at 80° C. for one hour, and furthermore, heated at 110° C. for one hour, thereby forming a 50 μm-thick inorganic solid electrolyte layer. After that, the composition for a secondary battery negative electrode prepared above was further applied onto the dried solid electrolyte composition, heated at 80° C. for one hour, and furthermore, heated at 110° C. for one hour, thereby forming a 100 μm-thick negative electrode active material layer. A 20 μm-thick copper foil (collector) was overlaid on the negative electrode active material layer, heated and pressurized using a heat press machine so that the inorganic solid electrolyte layer and the negative electrode active material layer obtained arbitrary densities, thereby producing an electrode sheet for an all solid state secondary battery shown in Table 4.

The layer constitutions of the electrode sheets for an all solid state secondary battery are shown in FIG. 1. The electrode sheets for an all solid state secondary battery have laminate structures of an aluminum foil/a negative electrode active material layer/an inorganic solid electrolyte layer/a positive electrode sheet for a secondary battery (a positive electrode active material layer/an aluminum foil).

<Production of all Solid State Secondary Battery>

A disc-shaped piece having a diameter of 14.5 mm was cut out from the electrode sheet for a secondary battery produced above and put into a 2032-type stainless steel coin case into which a spacer and a washer were combined, thereby producing an all solid state secondary battery shown in Table 4.

<Evaluation>

The following evaluations were carried out on the electrode sheets for an all solid state secondary battery and the all solid state secondary batteries of the examples and the comparative example produced above. The evaluation results are shown in Table 4.

<Evaluation of Battery Voltages>

The battery voltage of the all solid state secondary battery produced above was measured using a charging and discharging evaluation device “TOSCAT-3000” manufactured by Toyo System Co., Ltd.

Charging was carried out at a current density of 2 A/m² until the battery voltage reached 4.2 V, and, after the battery voltage reached 4.2 V, constant-voltage charging was carried out until the current density reached less than 0.2 A/m². Discharging was carried out at a current density of 2 A/m² until the battery voltage reached 3.0 V. Charging and discharging were repeated three times as one cycle, the battery voltage after the 5 mAh/g discharging at the third repetition was read and evaluated using the following standards. Meanwhile, evaluation levels A and B are pass levels of the present test.

—Evaluation Standards —

A: The battery voltage is 4.0 V or more.

B: The battery voltage is 3.9 V or more and less than 4.0 V.

C: The battery voltage is 3.8 V or more and less than 3.9 V.

D: The battery voltage is less than 3.8 V.

<Evaluation of Cycle Characteristics>

The cycle characteristics of the all solid state secondary battery produced above were measured using a charging and discharging evaluation device “TOSCAT-3000” manufactured by Toyo System Co., Ltd.

Charging and discharging were carried out under the same conditions as in the evaluation of the battery voltage. The discharge capacity at the third cycle was set to 100, and the cycle characteristics were evaluated from the number of cycles at which the discharge capacity reached less than 80 using the following standards. Meanwhile, evaluation levels A and B are pass levels.

—Evaluation Standards—

A: The number of cycles is 50 times or more.

B: The number of cycles is 40 times or more and less than 50 times.

C: The number of cycles is 30 times or more and less than 40 times.

D: The number of cycles is less than 30 times.

<Evaluation of Moisture Resistance>

Two disc-shaped pieces having a diameter of 14.5 mm were cut out from the electrode sheet for a secondary battery produced above, one piece was put into a 2032-type stainless steel coin case under an argon atmosphere (dew point: −40° C.), and an all solid state secondary battery was produced using an ordinary production method and the same method as the production of the all solid state secondary battery. Another piece was put into a 2032-type stainless steel coin case under an argon atmosphere with a humidity of 5%, and an all solid state secondary battery was produced using a production method at a high humidity and the same method as the production of the all solid state secondary battery.

For the two different all solid state secondary batteries, the numbers of cycles when the discharge capacities reached less than 80 respectively were measured under the same conditions as the evaluation of the cycle characteristics. The performance maintenance percentage of the battery was obtained from the following expression, and the moisture resistance was evaluated using the following standards. Meanwhile, evaluation levels A and B are pass levels.

Performance maintenance percentage (%)=(the number of cycles of an all solid state secondary battery produced using a production method at a high humidity)/(the number of cycles of an all solid state secondary battery produced using an ordinary production method)×100

—Evaluation Standards—

A: The performance maintenance percentage is 90% or more.

B: The performance maintenance percentage is 70% or more and less than 90%.

C: The performance maintenance percentage is 30% or more and less than 70%.

D: The performance maintenance percentage is less than 30%.

In Table 4, Example 1 to Example 10 are electrode sheets for an all solid state secondary battery and all solid state secondary batteries for which the solid electrolyte composition of the embodiment of the present invention was used, and Comparative Example 1 to Comparative Example 4 are electrode sheets for an all solid state secondary battery and all solid state secondary batteries for which the comparative solid electrolyte composition was used. Meanwhile, in Table 4, battery voltages are abbreviated as voltages.

TABLE 4

| All solid | | | | Battery evaluation | | |
|---|---|---|---|---|---|---|
| state | Positive | Solid | Negative | | | Moisture |
| secondary | electrode | electrolyte | electrode | | Cycle | resistance |
| battery | Composition | Composition | Composition | Voltage | characteristics | evaluation |
| Example 1 | U-2 | HK-1 | HS-1 | A | A | C |
| Example 2 | HU-1 | HK-1 | S-4 | B | B | C |
| Example 3 | U-5 | HK-2 | S-5 | B | B | B |
| Example 4 | U-6 | K-6 | S-6 | B | B | A |
| Example 5 | U-7 | K-7 | S-7 | A | B | A |
| Example 6 | U-8 | K-8 | S-8 | B | A | B |
| Example 7 | U-2 | K-2 | S-8 | A | A | A |
| Example 8 | U-4 | K-2 | S-8 | A | A | A |
| Example 9 | U-5 | K-7 | S-2 | A | A | A |
| Example 10 | U-6 | K-8 | S-2 | A | A | A |
| Comparative | HU-1 | HK-1 | HS-1 | A | D | C |
| Example 1 | | | | | | |
| Comparative | HU-2 | HK-2 | HS-2 | B | C | A |
| Example 2 | | | | | | |
| Comparative | HU-1 | HK-3 | HS-2 | D | C | C |
| Example 3 | | | | | | |
| Comparative | HU-2 | HK-1 | HS-1 | A | D | B |
| Example 4 | | | | | | |

<Stability of Composition Dispersion Liquids>

The stability of a dispersion liquid of the composition for a positive electrode, the solid electrolyte composition, and the composition for a negative electrode which were used to produce the all solid state secondary batteries was evaluated. The stability was evaluated using the following evaluation standards by dispersing the compositions, leaving the dispersion liquid to stand for 24 hours, and visually confirming the appearance of settlement of the positive electrode active material, the negative electrode active material, or the solid electrolyte. The evaluation results are shown in Table 5.

—Evaluation Standards—

A: The positive electrode active material, the negative electrode active material, and the solid electrolyte do not settle

B: The positive electrode active material, the negative electrode active material, and the solid electrolyte settle, but the contrasting density unevenness is observed in the composition

C: Half or more of the positive electrode active material, the negative electrode active material, and the solid electrolyte settle

D: The positive electrode active material, the negative electrode active material, and the solid electrolyte fully settle

TABLE 5

| | Composition for | Stability evaluation |
|---|---|---|
| | positive electrode | of composition |
| Example A | U-2 | A |
| Example B | U-4 | A |
| Example C | U-5 | A |
| Example D | U-6 | A |
| Example E | U-7 | B |
| Example F | U-8 | A |
| Comparative Example a | HU-1 | C |
| Comparative Example b | HU-2 | D |
| | Solid electrolyte | Stability evaluation |
| | composition | of composition |
| Example G | K-2 | A |
| Example H | K-6 | A |
| Example I | K-7 | A |
| Example J | K-8 | A |
| Comparative Example c | HK-1 | D |
| Comparative Example d | HK-2 | D |
| Comparative Example e | HK-3 | D |
| | Composition for | Stability evaluation |
| | negative electrode | of composition |
| Example K | S-2 | A |
| Example L | S-4 | A |
| Example M | S-5 | B |
| Example N | S-6 | B |
| Example O | S-7 | A |
| Example P | S-8 | A |
| Comparative Example f | HS-1 | C |
| Comparative Example g | HS-2 | C |

As shown in Table 4, it is found that, in the examples in which at least one layer of the positive electrode active material layer, the inorganic solid electrolyte layer, or the negative electrode active material layer included the inorganic solid electrolyte (A) and the compound (B) represented by General Formula (1), the cycle characteristics were satisfied while the voltage was maintained, furthermore, performance deterioration was not observed under a high humidity condition, and the cycle characteristics and the moisture resistance were both excellent.

In addition, as shown in Table 5, it is found that the solid electrolyte composition of the embodiment of the present invention was also excellent in terms of the stability of the composition; however, for example, in a case in which the comparative composition (HU-1 or the like) was used, conversely, the stability of the composition was poor.

The content of JP2015-039452 filed on Feb. 27, 2015 is incorporated into the present specification by reference.

All of the documents, patent applications, and technical standards described in the present specification are incorporated into the present specification by reference as much as a case in which the incorporation of the respective documents, patent applications, and technical standards by reference is specifically and individually described.

What is claimed is:

1. A solid electrolyte composition comprising:
an inorganic solid electrolyte (A) having a conductivity of ions of metals belonging to Group I or II of the periodic table; and
a compound (B) represented by General Formula (1), 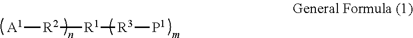
in General Formula (1), R¹ represents an m+n-valent linking group,
R² represents a single bond or a divalent linking group, and A¹ represents a monovalent group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group,
R³ represents a single bond or a divalent linking group, and P¹ represents a group having a hydrocarbon group having 8 or more carbon atoms,
m represents 1 to 8, n represents 1 to 9, and m+n satisfies 3 to 10, and
in a case in which m is 2 or more, two or more P¹'s and two or more R³'s each may be identical to or different from each other; and in a case in which n is 2 or more, two or more A¹'s and two or more R²'s each may be identical to or different from each other.

2. The solid electrolyte composition according to claim 1,
wherein the compound (B) represented by General Formula (1) is a compound represented by General Formula (2), 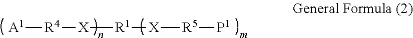
in General Formula (2), R¹ represents an m+n-valent linking group,
R⁴ represents a single bond or a divalent linking group, and A¹ represents a monovalent group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group,
R⁵ represents a single bond or a divalent linking group, and P¹ represents a group having a hydrocarbon group having 8 or more carbon atoms,
m represents 1 to 8, n represents 1 to 9, and m+n satisfies 3 to 10,
in a case in which m is 2 or more, two or more P¹'s and two or more R⁵'s each may be identical to or different from each other; and in a case in which n is 2 or more, two or more A¹'s and two or more R⁴'s each may be identical to or different from each other, and
X represents an oxygen atom or a sulfur atom.

3. The solid electrolyte composition according to claim 1,
wherein A¹ is a monovalent group including at least one group selected from a carboxyl group, an amino group, a thiol group, and a hydroxyl group.

4. The solid electrolyte composition according to claim 1,
wherein a formula weight of the group represented by P¹ is 200 or more and less than 100,000.

5. The solid electrolyte composition according to claim 1,
wherein P¹ is at least one group selected from an aliphatic hydrocarbon group having 8 or more carbon atoms, an aryl group having 8 or more carbon atoms, a polyvinyl residue including a hydrocarbon group having 8 or more carbon atoms, a poly(meth)acrylic residue including a hydrocarbon group having 8 or more carbon atoms, a polyester residue including a hydrocarbon group having 8 or more carbon atoms, a polyamide residue including a hydrocarbon group having 8 or more carbon atoms, a fluorinated polyvinyl residue including a hydrocarbon group having 8 or more carbon atoms, a fluorinated poly(meth)acrylic residue including a hydrocarbon group having 8 or more carbon atoms, a fluorinated polyester residue including a hydrocarbon group having 8 or more carbon atoms, and a fluorinated polyamide residue including a hydrocarbon group having 8 or more carbon atoms.

6. The solid electrolyte composition according to claim 1,
wherein R¹ is a polyhydric sugar alcohol residue.

7. The solid electrolyte composition according to claim 1,
wherein a weight-average molecular weight of the compound (B) represented by General Formula (1) is 600 or more and less than 200,000.

8. The solid electrolyte composition according to claim 1, further comprising:
a binder (C).

9. The solid electrolyte composition according to claim 1,
wherein the inorganic solid electrolyte (A) is a sulfide-based inorganic solid electrolyte.

10. The solid electrolyte composition according to claim 1,
wherein the inorganic solid electrolyte (A) is an oxide-based inorganic solid electrolyte.

11. The solid electrolyte composition according to claim 1,
wherein a content of the compound (B) represented by General Formula (1) is 0.01 parts by mass or more and 20 parts by mass or less with respect to 100 parts by mass of the inorganic solid electrolyte (A).

12. The solid electrolyte composition according to claim 1, further comprising:
a hydrocarbon-based solvent as a dispersion medium (D).

13. An electrode sheet for a battery comprising:
a collector; and
an inorganic solid electrolyte-containing layer disposed on the collector using the solid electrolyte composition according to claim 1.

14. The electrode sheet for a battery according to claim 13, further comprising:
a positive electrode active material layer;
a negative electrode active material layer; and
an inorganic solid electrolyte layer disposed between the positive electrode active material layer and the negative electrode active material layer,
wherein at least one layer of the positive electrode active material layer, the negative electrode active material layer, or the inorganic solid electrolyte layer is the inorganic solid electrolyte-containing layer.

15. A method for manufacturing an electrode sheet for a battery, comprising:
a step of applying the solid electrolyte composition according to claim 1 onto a collector to form an inorganic solid electrolyte-containing layer.

16. An all solid state secondary battery comprising:
a collector;
a positive electrode active material layer;
a negative electrode active material layer; and
an inorganic solid electrolyte layer disposed between the positive electrode active material layer and the negative electrode active material layer,
wherein at least one layer of the positive electrode active material layer, the negative electrode active material layer, or the inorganic solid electrolyte layer includes an inorganic solid electrolyte (A) having a conductivity of ions of metals belonging to Group I or II of the periodic table and a compound (B) represented by General Formula (1), 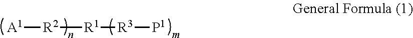
in General Formula (1), R¹ represents an m+n-valent linking group,
R² represents a single bond or a divalent linking group, and A¹ represents a monovalent group including at least one group selected from an acidic group, a group having a basic nitrogen atom, a (meth)acryloyl group, a (meth)acrylamide group, an alkoxysilyl group, an epoxy group, an oxetanyl group, an isocyanate group, a cyano group, a thiol group, and a hydroxyl group,
R³ represents a single bond or a divalent linking group, and P¹ represents a group having a hydrocarbon group having 8 or more carbon atoms,
m represents 1 to 8, n represents 1 to 9, and m+n satisfies 3 to 10, and
in a case in which m is 2 or more, two or more P¹'s and two or more R³'s each may be identical to or different from each other; and in a case in which n is 2 or more, two or more A¹'s and two or more R²'s each may be identical to or different from each other.

17. A method for manufacturing an all solid state secondary battery, comprising:
a step of applying the solid electrolyte composition according to claim 1 onto a collector to form an inorganic solid electrolyte-containing layer, thereby manufacturing an electrode sheet for a battery.
